(19) United States
(12) Patent Application Publication
(10) Pub. No.: US 2003/0212654 A1
(43) Pub. Date: Nov. 13, 2003

(54) Data integration system and method for presenting 360° customer views

(76) Inventors: Jonathan E. Harper, Louisville, CO (US); Benjamin R. Pope, Longmont, CO (US); Rufus Wavell, Boulder, CO (US); Jeffrey Barry, Denver, CO (US); William P. Myers, Thornton, CO (US); Bipin Paracha, Longmont, CO (US); Patrick Handerhan, Longmont, CO (US); Eric Severson, Broomfield, CO (US); Gary Foster, Loveland, CO (US); John Torrance, Lafayette, CO (US)

Correspondence Address: FENWICK & WEST LLP, SILICON VALLEY CENTER, 801 CALIFORNIA STREET, MOUNTAIN VIEW, CA, 94041, US

(21) Appl. No.: 10/351,295

(22) Filed: Jan. 23, 2003

Related U.S. Application Data
(60) Provisional application No. 60/351,842, filed on Jan. 25, 2002.
(60) Provisional application No. 60/360,064, filed on Feb. 25, 2002.

(51) Int. Cl. G06F 7/00

(52) U.S. Cl. 707/1

(57) ABSTRACT

A data integration system and method collects and stores customer information from disparate information sources in real-time. The stored information can be retrieved and assembled for presentation to a user according to the role and/or security profile of the user. The customer information is presented through a 360° viewer, which is embedded in an application or a browser, or runs as a standalone viewer. A data correlation system and method correlates data records collected from disparate Customer Relationship Management (CRM) applications using a three-tier approach comprising deterministic correlation, heuristic correlation and historical correlation. The correlation rules are fully configurable and extensible.

### CROSS-REFERENCE TO RELATED APPLICATIONS

This application claims the benefit of U.S. Provisional Application Nos. 60/351,842 and 60/360,064, filed Jan. 25, 2002 and Feb. 25, 2002, respectively, which applications are incorporated by reference herein.

This application is related to U.S. application Ser. No. 09/915,492, entitled “Method Integration Framework For Multi-Application Systems,” filed Jul. 25, 2001, which application is incorporated by reference herein.

### BACKGROUND

1. Field of the Invention

The present invention relates generally to computer networking, and more particularly, to collecting and assembling information from disparate data sources in real-time and organizing and presenting the collected information to a user via a User Interface (UI).

2. Background

Despite the availability of various modes of communication, such as email and the World Wide Web, many businesses still find it difficult to effectively manage customer relationships. Typical customer relationship management (CRM) goals include the ability to: (i) measure and improve the lifetime value of a customer, (ii) deliver appropriate value consistently, no matter how the customer interacts with the business, and (iii) predict and encourage desired customer behaviors. To achieve these lofty goals, a business needs to track customer contacts and information across various communication channels and to make the information available to all its customer-facing employees. Such information would enable a business to provide seamless, high-quality service to its customers.

Various vendors have developed CRM solutions, which purport to enable a clear and common understanding, across an entire enterprise, of who the customers are and how to deliver value to them. Businesses using these CRM solutions, however, have typically found it difficult to proactively adjust relationships with their customers, whether it be developing relationships with high value customers, or moving lower value customers to self-service. In particular, these solutions failed to address fragile infrastructures, control high maintenance costs, and add new communication channels or CRM functionality. Solutions that worked in pilot or departmental deployments were later discovered to have significant scalability issues, or difficult to integrate with new products and new product releases as CRM technology evolved. Thus, after spending a great deal of money on a variety of CRM systems, most businesses have found themselves in the midst of spending even more, often in the context of projects that would take many years to implement.

CRM has typically grown up in stages, starting with traditional call centers whose systems were built around phone switches. As new functions arose across different business units, new call centers were often built independently, resulting in multiple customer systems disconnected from the core Information Technology (IT) infrastructure. When more sophisticated CRM and contact center software became available, they were typically implemented separately within each call center. Mergers and acquisitions only compounded this situation, as they tended to drop in a whole new set of tools, applications, procedures and people, which come from different IT philosophy and history. Today, it is not uncommon for many organizations to have multiple CRM products in different departments, and sometimes multiple, independent versions of the same product.

As new contact channels like email and the Web arose, the problem became even worse. Email agents are often physically separated from the telephone call centers, and have no access to the information generated by the call center. Web site interactions, such as using tools that indicate specific buying interest, may not be tracked at all. These disconnected application and information “silos” let businesses see only a partial view of a customer, and make it difficult to provide the customer with a consistent and coherent service. Unless customer data and systems are connected, businesses do not have all the information needed to sell effectively. Moreover, these businesses will find it difficult to handle service issues, close sales in a single contact, and proactively develop relationships with high value customers, because they do not have the data needed to optimize service levels while controlling costs.

Up to now, this problem has either been ignored or approached with fragile point integrations between CRM applications. Some vendors have tried screen-scraping or limited integrations at the desktop, while others have approached this issue through central data warehousing. But none of these approaches have solved the problem of providing a real-time, synchronized and complete customer view.

Searching for a solution, a growing number of companies have considered making a wholesale replacement of existing systems with a central CRM suite. In theory, if a new enterprise-scale suite is adopted, then all departments can share the same system and the same application. Unfortunately, CRM packages are typically focused on functions and features and not on providing the cross-divisional and holistic customer view that is desired. While CRM packages can be powerful additions to an overall CRM strategy, they typically require re-training the people who use the existing applications and re-creating the business logic embedded in the existing CRM systems and applications. This is why initiatives to deploy CRM packages have proven to be costly and often take multiple years to complete.

Accordingly, there is a need for a CRM solution that provides a way to collect, assemble and present customer data across an enterprise, while removing application and information “silos” in the process. Such a solution should include dynamically connecting existing systems to enable CRM applications running on disparate platforms to share relevant contact information in real-time, and impose business logic that transcends the scope of any individual CRM application. As the relevant data is collected, it should be aggregated into a consolidated, real-time 360° view of the customer's value and history. Finally, the customer data should be filtered to present the right information, in the right format, relevant to the task at hand and the role and security status of the user requesting the information in the enterprise.

One particular problem associated with integrating disparate CRM applications is the correlation of customer data records generated by disparate CRM applications. When correlating data records between disparate CRM systems, two records may not be the same for the same customer. This can occur if the CRM applications (i) use different numbering schemes, (ii) use different field names that actually represent the same data, (iii) contain misspelled names or addresses, and/or (iv) use names or addresses that have been changed.

Deterministic solutions to this problem are straightforward and predictable but typically cannot tolerate variations in spelling, or in formats that are not easily standardized. Heuristic solutions (e.g., fuzzy logic) can match names and addresses even when spelled differently but typically cannot match names and addresses that are truly different, but still belong to the same customer (e.g., multiple valid addressees, individual vs. practice name, change in married name, etc.). Referential solutions use external reference sources that contain known cross-referencing between multiple names and addresses, but typically will only find matches that are known to the reference database, and spelled the same as in the database.

Accordingly, there is a need for a data correlation system and method for accurately and consistently correlating customer data records generated by disparate CRM applications.

### SUMMARY OF THE INVENTION

The present invention overcomes the deficiencies of conventional techniques by collecting and storing customer information from disparate information sources in real-time. The stored information can be retrieved and assembled as a structured result set for presentation to a user according to the role and/or security profile of the user. The customer information is presented through a 360° viewer, which can be embedded in an application or a browser, or run as a standalone viewer. The role of the user and the data types accessible to the user based on the role can be configured using metadata definitions.

In one embodiment of the present invention, a data integration system comprises a collection module for collecting information in real-time from at least one information source; a storage device coupled to the collection module for storing a portion of the collected information in accordance with configurable metadata definitions; and a retrieval module coupled to the storage device for retrieving a selected portion of the collected information from the storage device for presentation to a user, wherein the selection of information is based on the role of the user defined by the configurable, metadata definitions.

In another embodiment of the present invention, a data integration method comprises collecting information in real-time from at least one information source; storing a portion of the collected information in a storage device in accordance with configurable metadata definitions; and retrieving a selected portion of the collected information from the storage device for presentation to a user, wherein the selection of information is based on the role of the user defined by the configurable metadata definitions.

In another embodiment of the present invention, a viewer for constructing and presenting a 360-degree customer view of a customer based on data collected from Customer Relationship Management (CRM) applications comprises a viewer for presenting a configurable user interface to a user, and a controller coupled to the viewer for constructing the user interface in accordance with configuration data and the role of the user.

In another embodiment of the present invention, a data correlation system for correlating data records collected from disparate CRM applications comprises a configurable correlation module for applying a multi-tier correlation process to the data records. The correlation process includes three correlation techniques: deterministic correlation, heuristic correlation, and referential correlation. The system also includes a correlation data structure coupled to the correlation module for storing the results of the correlation process for use in a subsequent correlation process. A referential database can be coupled to the correlation module for providing unique keys associated with data records for use in the deterministic correlation process.

In another embodiment of the present invention, a method of correlating data records collected from disparate CRM applications comprises: comparing data fields in a first data record to data fields in a second data record to determine at least one matching field; and, if first data fields in the data records are an exact match and the probability that second data fields in the data records match exceeds a predetermined threshold, recording a successful match in a data structure for use with a subsequent comparison of data records. Prior to correlation, data records can be normalized to a common format and/or enriched with additional data.

### BRIEF DESCRIPTION OF THE DRAWINGS

FIG. 1 is a block diagram of a data integration system for CRM applications, in accordance with one embodiment of the present invention.

FIG. 2 is a block diagram of an adapter for collecting customer information, in accordance with one embodiment of the present invention.

FIG. 3 is a list of exemplary metadata definitions for use in the metadata database shown in FIG. 1.

FIG. 4 is a list of exemplary fields and corresponding attributes for metadata definitions, in accordance with one embodiment of the present invention.

FIG. 5 is flow diagram of a data correlation process, in accordance with one embodiment of the present invention.

FIG. 6 is a flow diagram of a correlation rule structure, in accordance with one embodiment of the present invention.

FIG. 7 is a screen shot of a viewer embedded in an application, in accordance with one embodiment of the present invention.

FIG. 8 is a screen shot of a viewer as a standalone application, in accordance with one embodiment of the present invention.

FIG. 9 is a block diagram illustrating an application server environment in accordance with one embodiment of the present invention.

FIG. 10 is a flow diagram of a connection instantiation process used by the application server environment shown in FIG. 9, in accordance with one embodiment of the present invention.

FIG. 11 is a block diagram of the architecture of the 360-degree Server shown in FIG. 1, in accordance with one embodiment of the present invention.

FIG. 12 is a block diagram of the Metadata Access/Repository shown in FIG. 11, in accordance with one embodiment of the present invention.

FIG. 13 is a block diagram of the Database Adapter shown in FIG. 11, in accordance with one embodiment of the present invention.

FIG. 14 is a block diagram of the Middleware Services module shown in FIGS. 1 and 11, in accordance with one embodiment of the present invention.

FIG. 15 is a block diagram of the Data Collection and Retrieval module shown in FIG. 11, in accordance with one embodiment of the present invention.

FIG. 16 is a block diagram of the Data Delivery module shown in FIG. 11, in accordance with one embodiment of the present invention.

FIG. 17 is a graphical representation of an exemplary process model, in accordance with one embodiment of the present invention.

FIG. 18 is a tabular representation of the process model shown in FIG. 17, in accordance with one embodiment of the present invention.

FIG. 19 is tabular representation showing the relationship between the process model shown in FIGS. 17 and 18 and XML generated from the process model, in accordance with one embodiment of the present invention.

FIG. 20 is a block diagram of the GBO Builder shown in FIG. 11, in accordance with one embodiment of the present invention.

### DETAILED DESCRIPTION OF EMBODIMENTS

System Architecture

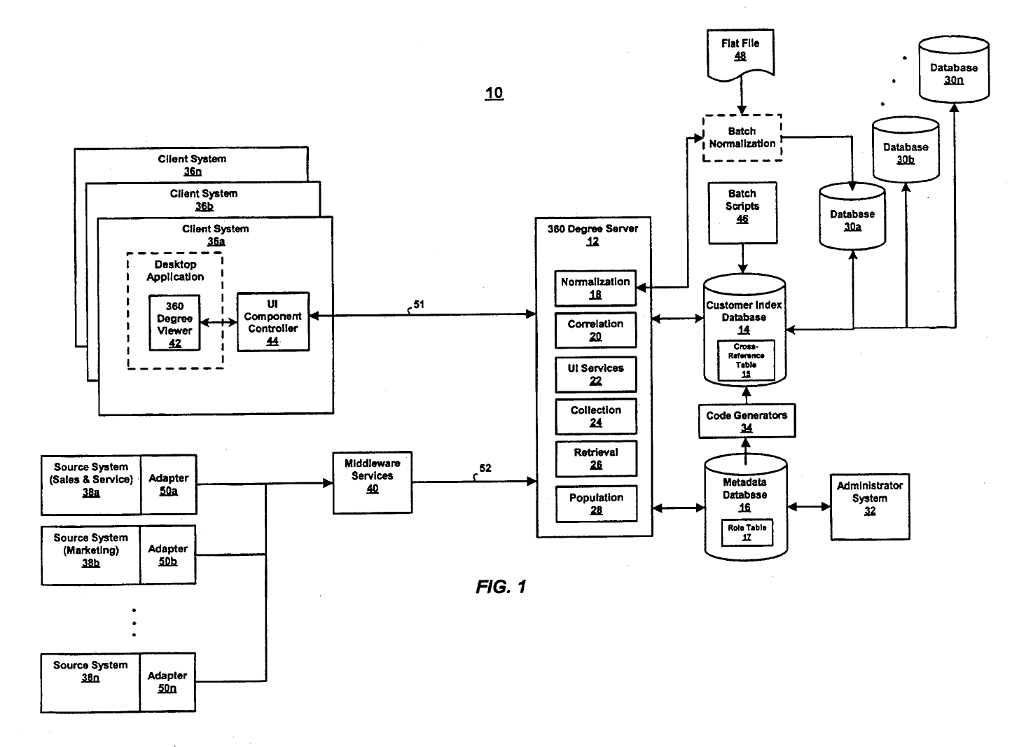

FIG. 1 is a block diagram of a data integration system 10 for CRM applications, in accordance with one embodiment of the present invention. CRM applications are broadly defined to mean any application that manages a particular aspect of a customer/client relationship (e.g., sales, service, marketing, communication interfaces, such as emails, telephone and websites, loyalty programs, etc.). Some examples of CRM applications include Siebel™ Sales Version 7 and Kana™ Response Version 5.0.

The system 10 generally includes 360 Server 12, Customer Index Database 14 and Metadata Database 16. The Server 12 includes Normalization module 18, Correlation module 20, UI Services module 22, Collection module 24, Retrieval module 26 and Population module 28. In one embodiment, the modules are software modules developed using Java™ and/or native C++ and are designed to support multiple instances in a load-balanced client-server configuration to support scalability and fail-over requirements. The software modules are stored on one or more computer-readable mediums as instructions, which are executed by one or more processors located in the Server 12. The Server 12 can be implemented on a variety of well-known computing platforms, including but not limited to Unix™, Solaris™ and Windows™ NT/2000. In one embodiment, the Customer Index Database 14 and the Metadata Database 16 are implemented with Oracle™ databases (e.g., Oracle database Version 8.1.7.1.0).

The Customer Index Database 14 (hereinafter also referred to as “Operational Data store 14” or “ODS 14”) is coupled to the Server 12 and to one or more relational databases 30a, 30b . . . 30n, which contain, for example, historical customer information related to past purchases, complaints, etc. The Metadata Database 16 is coupled to the Server 12 and to Administrator System 32. The Customer Index Database 14 communicates with the Metadata Database 16 via a Code Generator module 34. The Administrator System 32 is used to configure the Metadata Database 16 using, for example, Java™ Database Connectivity (JDBC) technology.

The Code Generator module 34 constructs procedural-language computer source code (e.g., PL/SQL) to create, read, update and delete records in the Customer Index Database 14. The Code Generator module 34 also constructs computer source code to perform correlation processing, including but not limited to, comparison of fields between database records, determining weighted probability scores for the field comparisons and thresholding the probability scores with thresholds stored in the Metadata Database 16.

The Customer Index Database 14 is also coupled to Initial Data Load (IDL) Batch Scripts module 46 to facilitate offline batch processing of IDL batch scripts. The batch processing can be used to initialize data loads, load and correlate large quantities of customer data in real-time, and extract data for warehousing and other enterprise data needs.

The Server 12 communicates with the Customer Index Database 14 and the Metadata Database 16 using well-known database connection technologies and protocols, such as SQL *Net and Oracle™ Call Interface (OCI).

The Server 12 is also coupled one or more Client Systems 36a, 36b, . . . 36n and to one or more Source Systems 38a, 38b, . . . 38n via a Middleware Services module 40 and a Middleware Bus 52 (e.g., IBM's MQSeries), using well-known connection technologies and protocols, such as Extensible Mark-up Language (XML) and Transmission Control Protocol (TCP). Source Systems 38a, 38b . . . 38n communicate with the Middleware Services module 40 using technologies and protocols specific to the particular source system. Source systems can include, but are not limited to sales and service systems, marketing automation systems and any other CRM applications.

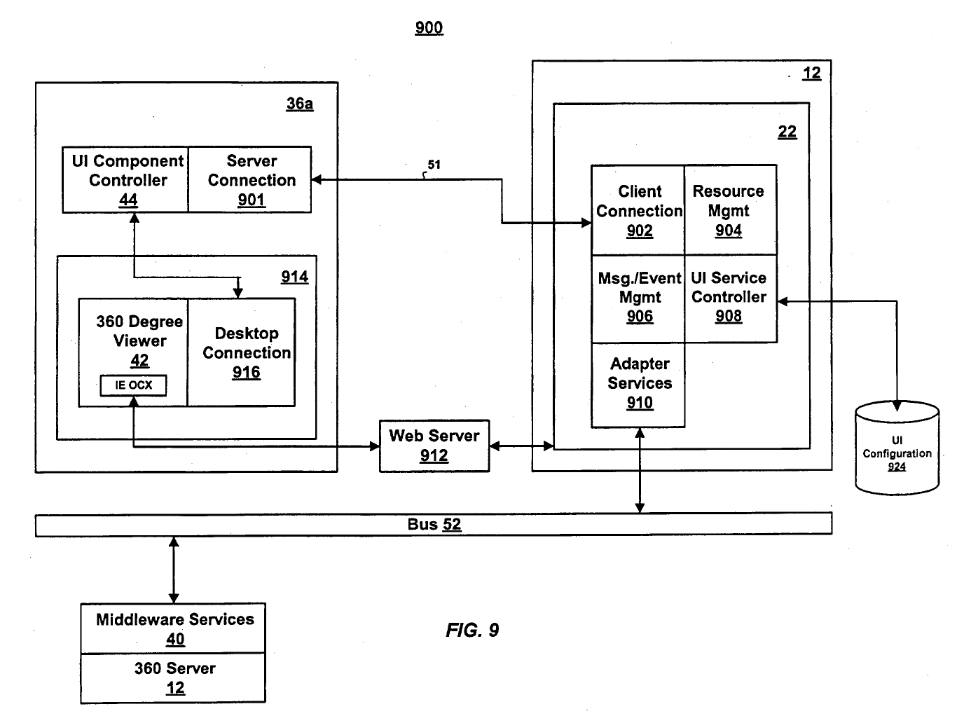

The Client Systems 36a, 36b, . . . 36n can be any well-known computer platforms, including but not limited to Windows™ 95, 98, NT, 2000, ME. Each of the Client Systems 36a, 36b, . . . 36n, includes a UI Component Controller 44 coupled to a 360-degree Viewer 42 for displaying UIs on a display device. The Viewer 42 is preferably embedded in a desktop CRM application, but can also be implemented as standalone viewer. Some examples of desktop CRM applications include, but are not limited to, Siebel™ Sales 7 and Kana™ Response 5.0. In one embodiment, the Client Systems 36a, 36b, . . . 36n communicate with the Server 12 over one or more communication link(s) 51 (e.g., TCP socket), as described more fully with respect to FIG. 9.

Data Collection

Customer information is collected by Collection module 24 and stored in the Customer Index Database 14. The Collection module 24 provides standard gateways to support a variety of data collection methods, including but not limited to pre-built adaptors for common CRM applications, database adapters to connect to custom applications, Enterprise Java™ Beans to connect Java™ 2, Java™ Enterprise Edition (J2EE) applications, and any other connections made through Message Oriented Middleware (MOM) adapters and other data extractors (e.g., ETL tools). The Collection module 24 collects relevant customer information/data from one or more Source Systems 38a, 38b, . . . 38n, including customer profile data, customer interaction data across one or more touch-points, relevant customer transaction data, and CRM analytical data.

In one embodiment, customer information is collected through batch processing using data extracts collected from relational databases 30a, 30b, . . . 30n (e.g., compact disc) or any other computer-readable medium. The data extracts are collected in accordance with IDL batch scripts and/or directly using Open Database Connectivity (ODBC) or an equivalent database connectivity protocol. Preferably, the data extracts are in readily accessible formats, such as Oracle™ DB, SQL DB, Database Format (DBF), command-delimited files (e.g., Flat File 48), or any other data format that is recognizable by the resident database management system used in conjunction with the Customer Index Database 14 (e.g., Oracle™ 8.1.7 DBMS). In one embodiment, data extracts from Flat File 48 (e.g., spreadsheet) are normalized by Normalization module 18 before being made available for collection. In one embodiment, the Normalization module 18 splits the data in the Flat File 48 into components, which can be linked to other related components to facilitate inclusion into one or more of the relational databases 30a, 30b, . . . 30n.

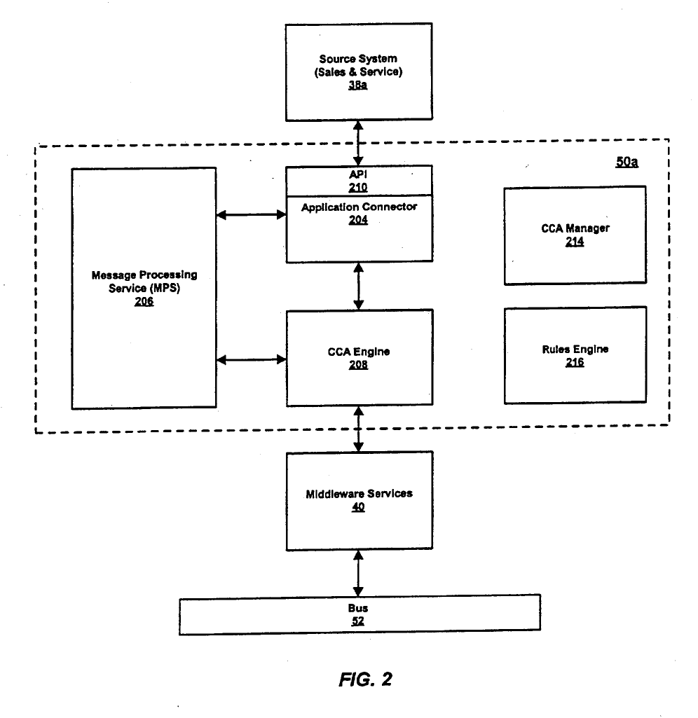

In one embodiment, the Collection module 24 performs real-time, event-driven, collection of customer information using adapters 50a, 50b, . . . 50n and the Middleware Bus 52, as described more fully with respect to FIG. 2. Adapters are programmable interfaces between the System 10 and various integrated CRM applications.

FIG. 2 is a block diagram of the Adapter 50a for collecting customer information from Source System 38a, in accordance with one embodiment of the present invention. The components of the Adapter 50a include a configurable Application Connector 204, Message Processing Service (MPS) module 206, ComponentClassAdapter (CCA) Engine 208, CCA Manager 214 and Rules Engine 216. Preferably, an adapter is developed for each of the Source Systems 38a, 38b, . . . 38n to be integrated into the System 10 using well-known object oriented programming techniques and programming languages (e.g., C++, J2EE Beans).

In one embodiment, the Application Connector 204 is coupled to the Source System 38a through an Application Programming Interface (API) 210. The API 210 handles delivery and receipt of events and data to and from the Source System 38a. The Application Connector 204 is coupled to the MPS module 206, which includes mechanisms for transforming and validating message contents. The transformation mechanism includes converting values stored within individual fields of the incoming message to and from a common format used by the System 10 to a format recognized by the Source System 38a. Some examples of transformations include converting “CA” to “California” and “Mr.,” to “Mister” (for salutation). The translation mechanism includes translating system objects into application objects. For example, a data object used in the Customer Index Database 14 for customer “trouble tickets” may have fifty fields but the fifty fields translate to ten fields in the corresponding application data object. The validation mechanism includes validating messages transmitted between the Server 12 and the Source System 38a.

The MPS module 206 is coupled to the CCA Engine 208, which contains generalized business process logic. The CCA Engine 208 calls a list of business functions that reside in the Rules Engine 216 and/or in a separate library in the Adapter 50a.

The CCA Manager 214 manages the functions in the Adapter 50a, including but not limited to startup, shutdown, creation of global objects (e.g., MPS 206), and configuration of the Adapter 50a.

Messages from the Middleware Bus

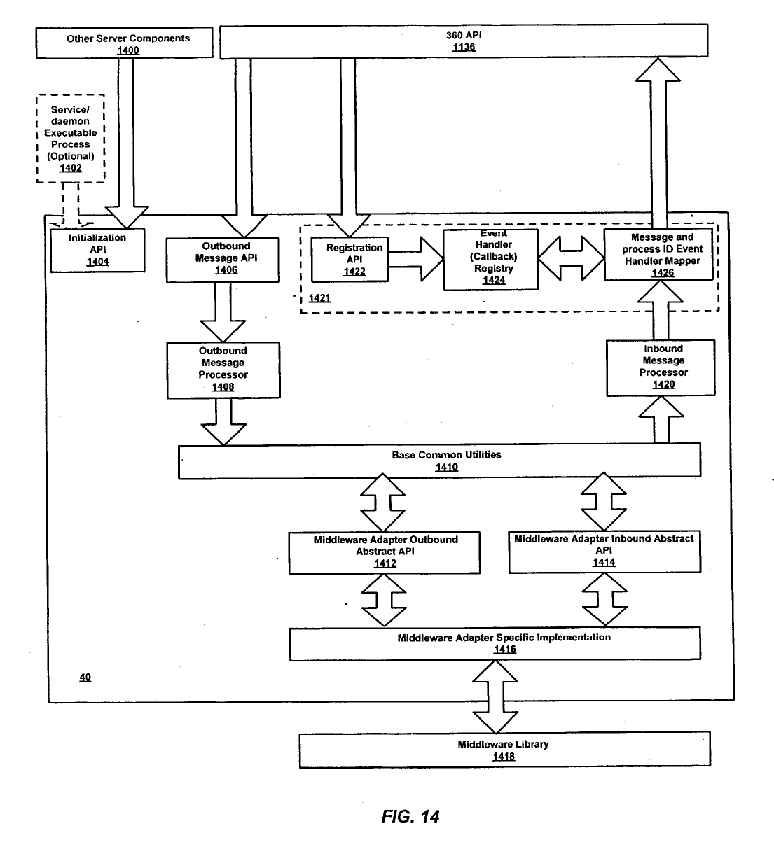

Messages generated by the Source System 38a are received by Middleware Services module 40, as described with respect to FIG. 14. The Middleware Services module 40 calls a function in the CCA Engine 208 in Adapter 50a, which was previously registered with the Middleware Services module 40 during startup. The CCA Engine 208 decides which business function to call and calls the business function. The business function works with the message and objects in a common format. When the function needs to interact with the Source System 38a, the relevant functions are called. The functions are implemented in the Application Connector 204 and use the MPS 206 to transform, translate and validate objects in the common format of System 10 into an application object recognizable by the Sales & Services application hosted on Source System 38a. The application object can then be used to save (e.g., update or insert), delete or query the Sales and Services application.

Events from the Application

Events from the Sales & Services application hosted on Source System 38a are received through the API 210 located in the Application Connector 204. The Sales & Services application calls the API 210 located in the Application Connector 204 based on the type of event generated by the Sales & Services application. The Application Connector 204 translates these calls into objects in common format using the MPS 206. Once the objects are built, the Application Connector 204 calls the appropriate business function in the CCA Engine 208 to create the message to be sent on the Middleware Bus 52. One example of a business function is the updating of a customer record when a new message is received from the Bus 52. The CCA Engine 208 uses the MPS 206 to validate the message. The message is sent using the Middleware Services module 40, which sends the message to the Server 12 via the Bus 52.

Population of the ODS

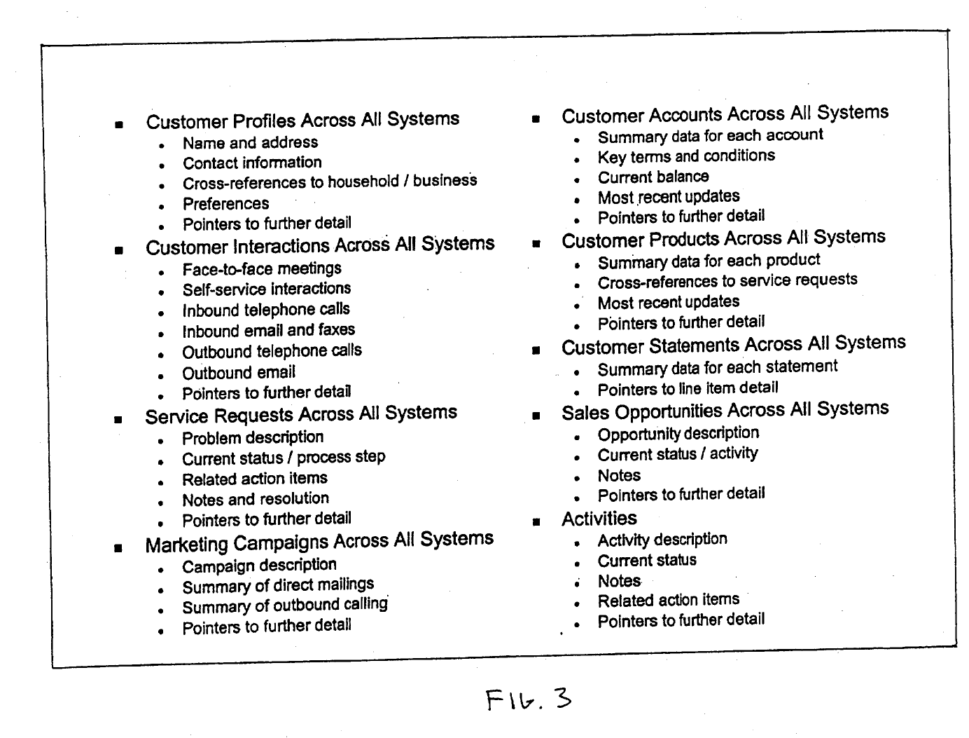

Customer information collected by Collection module 24 is used by Population module 28 located in Server 12 to populate the Customer Index Database 14. In one embodiment, the Customer Index Database 14 is a centralized and indexed, relational database populated with linked data summaries containing information for each customer that was collected by the Collection module 24. Preferably, the data summaries are linked to facilitate retrieval and are continuously updated in real-time. The customer information is summarized in accordance with configurable metadata definitions contained in the Metadata Database 16. For example, one metadata definition could be “Customer Profiles,” which includes the following customer information: name and address, contact information, cross-references to household/business, preferences, and pointers to data fields containing further detail on the customer. Other examples of metadata definitions are shown in FIG. 3.

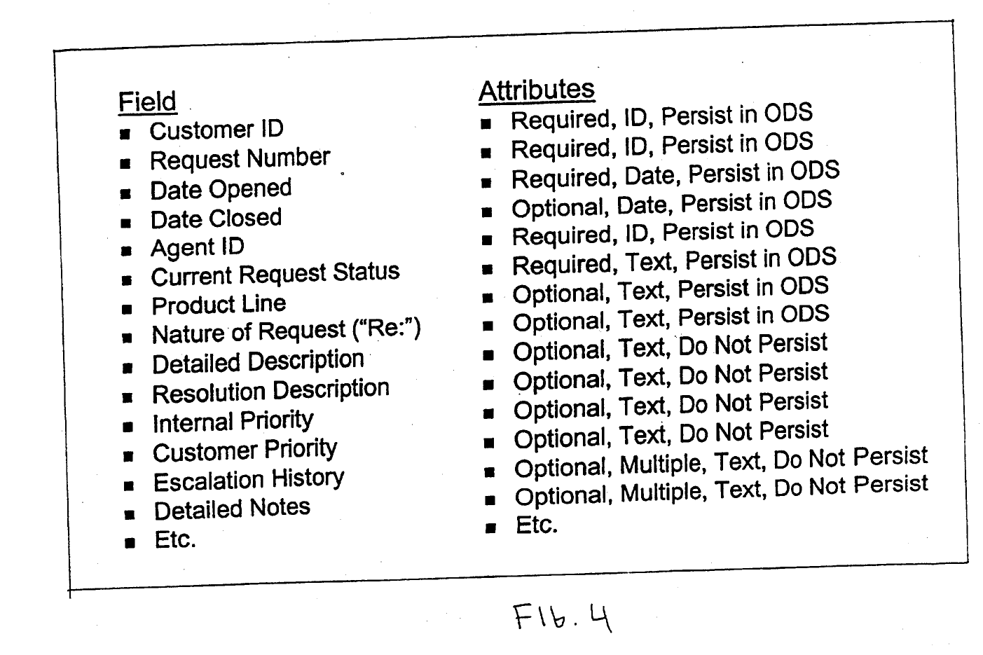

In one embodiment, each metadata definition is associated with data fields and attributes. For example, the metadata definition “Customer Profiles” could include a data field “Customer ID,” which is associated with the attributes “Required” and “Persist.” Thus, the Customer Index Database 14 includes for each customer a summary, including the Customer Profile containing the Customer ID, which is “Required” by the system and “Persists” (i.e., remains stored) in the Customer Index Database 14 until these attributes are changed by, for example, a system administrator via the Administrator System 32. Other examples of fields and attributes for metadata definitions are shown in FIG. 4. In a preferred embodiment, the Customer Index Database 14 does not store data fields that do not have the “Persist” attribute associated with the data field. When these fields are needed, they are accessed either by the Customer Index Database 14 links to the source database, or optionally through mechanisms of the GBO Builder 1110, a component of the 360 Server 12.

Data Correlation

Before the collected customer information is stored in the Customer Index Database 14, it is preferably correlated with previously stored customer data records. When correlating data between disparate, source systems (e.g., Source Systems 38a, 38b, . . . 38n), two records may not be the same for the same customer. This can occur if the Source Systems 38a, 38b, . . . 38n: (i) use different numbering schemes, (ii) use different field names that actually represent the same data, (iii) contain misspelled names or addresses, and/or (iv) use names or addresses that have been changed.

The Correlation module 20 solves these problems through a three-tier correlation approach, including deterministic correlation, heuristic correlation and historical correlation. Deterministic correlation is based on well-defined business rules, such as matching an account ID in one system to a social security number in another system. Heuristic correlation uses fuzzy logic and statistical frequency analysis to generate probable data matches, such as generating probable matches on names and addresses that appear similar. Historical correlation uses referential databases (e.g., databases developed by Acxiom Corporation of Little Rock, Ark.) that track known linkages between multiple instances of data, such as determining that two otherwise different customer records match, based on a known name or address change. In one embodiment, one or more referential databases are accessed via an external service adapter located in Server 12.

After Collection module 24 collects the customer information the Correlation module 20 compares the collected information with information stored in the Customer Index Database 14 to determine if any information has changed for a particular customer or if a new customer is being added to the System 10. In one embodiment, the collected data is standardized and normalized before being correlated. The standardized data is then compared against information stored in the Customer Index Database 14 using a Cross-reference Table 15. In one embodiment, the Cross-reference Table 15 is initialized manually but dynamically stores the results of previous correlations to lessen the need for manual review and to increase accuracy of future data correlations.

In another embodiment, the Cross-reference Table 15 is initialized through an automated data loading process, which runs the correlation rules (described in more detail below) on a large set of data in a batch mode. In a preferred embodiment, the Cross-reference Table 15 is bypassed and the linkage between different database records is stored directly in the Customer Index Database 14 using a correlation ID to link the records, which are considered to be matches by the correlation process.

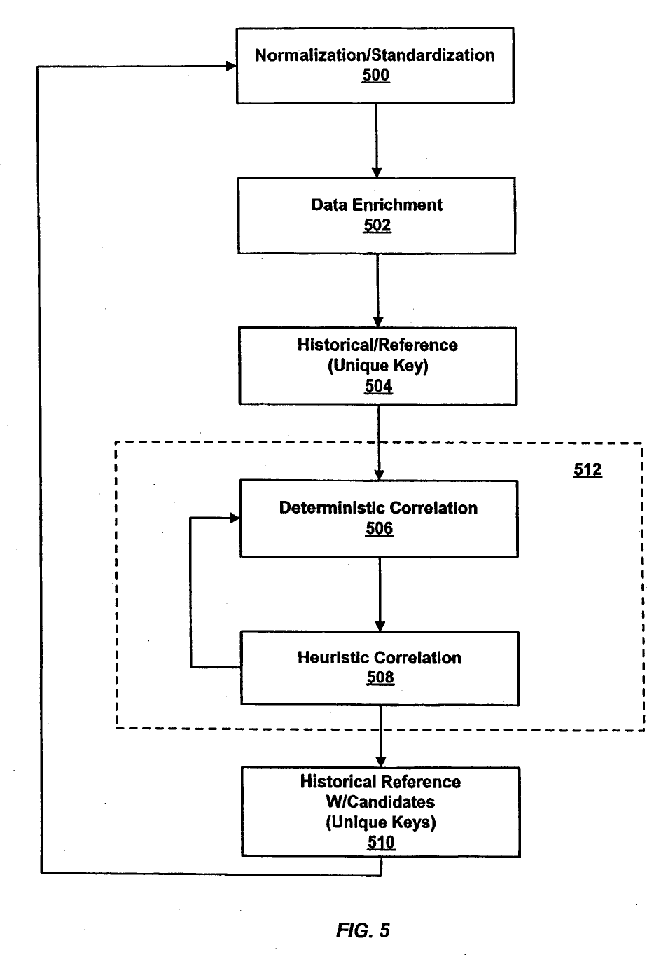

The comparison of collected information with the Customer Index Database 14 includes a combination of deterministic, heuristic and historical correlation techniques described above, which can be configured by a system administrator by changing the appropriate metadata definitions in the Metadata Database 16. Deterministic data correlation determines whether an exact match has occurred and heuristic data correlation generates a set of records that possibly match (candidate records) from the Customer Index Database 14, and then determines a match score for the candidate records. In heuristic correlation, the match scores for the candidate records are compared within the process flow to determine the best match of the candidate set. These correlation techniques can be implemented in a process flow, as described with respect to FIG. 5.

FIG. 5 is flow diagram of a data correlation process, in accordance with one embodiment of the present invention. Customer information is normalized/standardized 500 by placing it in a format that is compatible with information stored in the Customer Index Database 14. For example, a customer phone number formatted as the string “3038272100” is normalized into the format “(303) 827-2100.” In one embodiment, the customer information can be enriched 502 with additional information. For example, the customer address “2605 Trade Ctr Ave Ste B, Longmont, Colo.,” is normalized to “2605 Trade Center Avenue, Suite B, Longmont, Colo. 80503-7552.” In this example, the words “Ctr,” “Ave,” and “Ste” are spelled out and the customer's zip code is added.

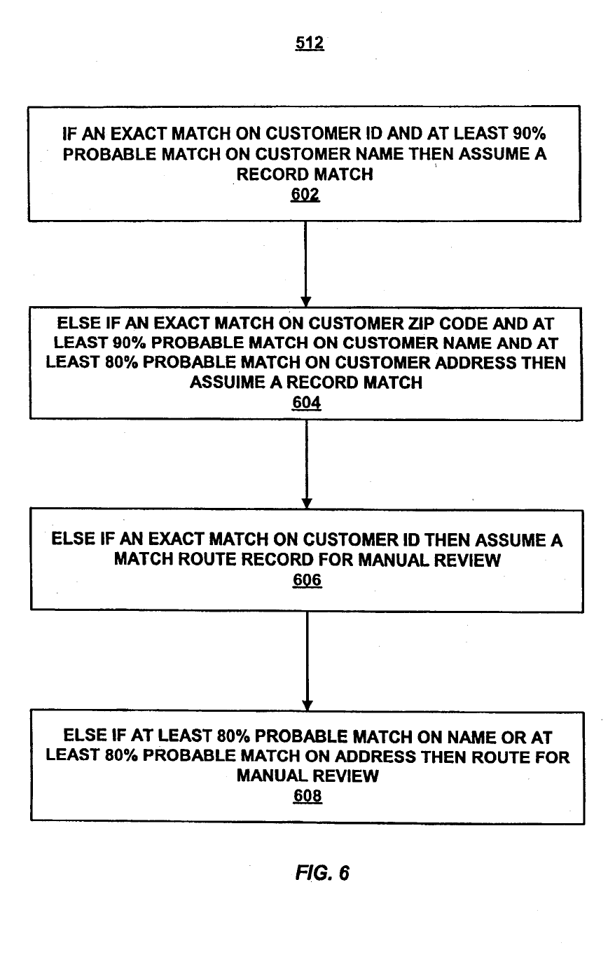

Next, a historical correlation 504 is performed by comparing the collected customer information to historical customer information stored in the Customer Index Database 14, to determine if a unique key is assigned to the customer. If a unique key is assigned to the customer, then a deterministic correlation 506 is performed between the collected information and information stored in the Customer Index Database 14 using the unique key as an index. If a unique key is not assigned to the customer, a heuristic correlation 508 is performed, resulting in a list of possible queries into the Customer Index Database 14. A second historical correlation 510 is then performed using the list of possible queries to identify a list of possible matching records. The process repeats itself until a successful match is achieved, or until all the rules have been processed unsuccessfully, in which case the records are not considered to be a match. In one embodiment, the deterministic and heuristic correlations steps 508, 512 are implemented in a Correlation Rule Structure 512, as described more fully with respect to FIG. 6.

FIG. 6 is a flow diagram of a Correlation Rule Structure 512, in accordance with one embodiment of the present invention. For this example, it is assumed that two customer records are being correlated and each record includes the following data fields: Customer ID, Customer Name, Customer Address and Customer Zip Code. The rules are implemented as follows:

If 602 an exact match on Customer ID and at least a 90% probable match on Customer Name, then assume a match, else if 604 an exact match on Customer Zip Code and at least a 90% probable match on Customer Name, and at least a 80% probable match on Customer Address, then assume a match, else if 606 an exact match on Customer ID, then assume a match but perform manual review of records, else if 608 at least 80% probable match on Customer Name or at least 86% probable match on Customer Address, then perform manual review of records. If the data passes none of these rules, then the records in question are determined not to be a match, and assigned different correlation IDs.

The individual rules in the Correlation Rule Structure 512 are designed to minimize the chance of overmatching (i.e., matching incorrectly) and multiple rules are used to minimize under-matching (i.e., to cover as many cases as possible). The correlation rules are preferably designed to minimize overlap and maximize coverage (i.e., to attack the problem from different angles to catch as many cases as possible). Additional rules can be developed to catch questionable situations to be routed for manual review, while minimizing manual review as much as possible through the use of the dynamic cross-correlation table or correlation ID located in the Customer Index Database 14. The percentages or weights used in the correlation rules can be configured as desired to achieve the appropriate results.

Data Retrieval & Assembly

The Customer Index Database 14 (as well as Source Systems 38a, 38b, . . . 38n and databases 30a, 38b, . . . 38n) can be queried in real-time for customer information, using predefined queries. Typical queries include, but are not limited to searching for customers, getting detail on a single customer, getting additional detail about a specific customer, and customer vectors (e.g., contacts, trouble tickets, orders, etc.). In one embodiment, predefined queries are processed by the Retrieval module 26, located in the Server 12 using SQL queries built from templates and objects located in the Server 12. The query results are formatted (e.g., XML formatted) and delivered by the UI Services module 22 to one or more Client Systems 36a, 36b, . . . 36n via communication link 51. Preferably, the Customer Index Database 14 is coupled to cache memory for providing detailed data for certain customers (e.g., current customer or customers in a queue), while detailed information for other customers remain in one or more of the Source Systems 38a, 38b, . . . 38n until needed.

Responsive to a user invoked query and/or a screen pop up event (i.e., a response to a programmatic request for customer information) from Client System 36a, the Retrieval module 26 located in Server 12 retrieves and assembles the requested customer information from the Customer Index Database 14 and/or other relational databases 30a, 30b, . . . 30n. The retrieval/assembly process begins with a customer information request from the Client System 36a. The request is transmitted to the Server 12 via communication link 51 using known connection protocols (e.g., TCP socket, IBM's MQSeries, XML), and a fully distributed (no central hub) messaging architecture.

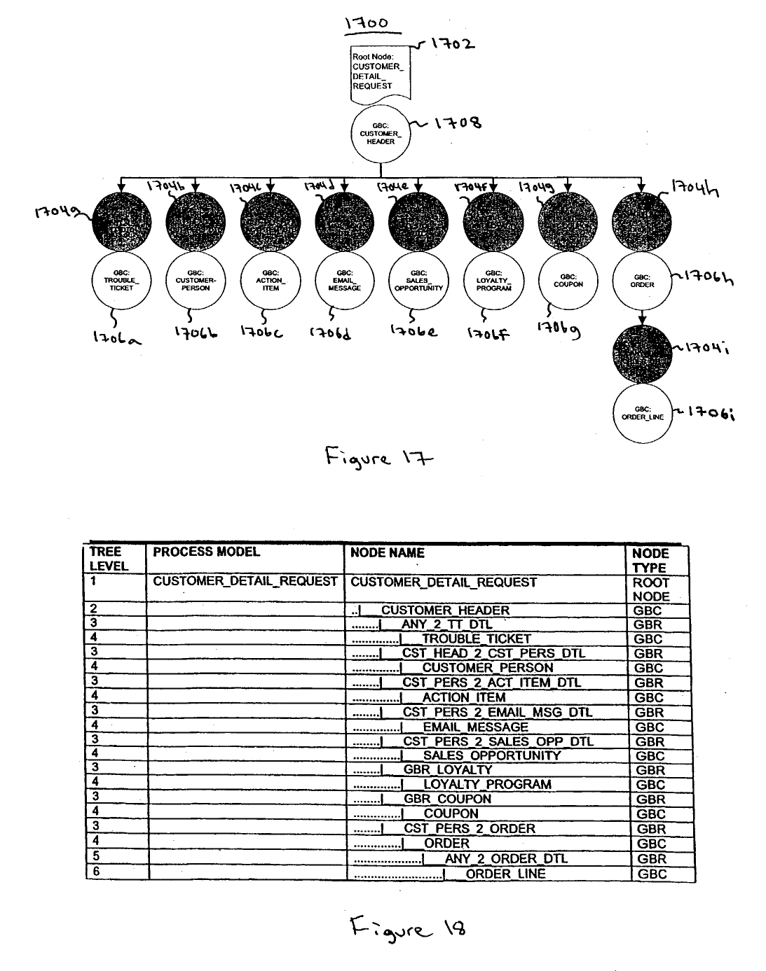

The request triggers one or more configurable process models stored in the Server 12 and provides various data elements to one or more process models. Process models and there relationship to metadata will be discussed more fully with respect to FIGS. 17-20.

In response to request messages from the Client System 36a, the appropriate process model automatically transforms the request into one or more relational database queries for retrieving the requested information from the Customer Index Database 14 and/or other databases 30a, 30b, . . . 30n. Once retrieved, the requested information is sent back to the Client System 36a via the UI Services module 22 located in Server 12 for display by the Viewer 42. The requested customer information is transmitted to the Client System 36a in a response message, which contains a stream of XML data, the hierarchy of which is organized in the same manner as the invoked process model is organized. This enables the organization of the data and hence the presentation of the data to the user to be configured using metadata definitions contained in the metadata database 16.

Data Presentation

At the Client System 36a, the requested customer information provided by the UI Services module 22 is received by the UI Component Controller 44 and displayed on the Viewer 42 in accordance with the user's preferences, security profiles and role within the enterprise (e.g., sales manager, service manager, marketing manager). In one embodiment, the UI Component Controller 44 is a memory resident application that uses a TCP-based protocol to manage (from the perspective of the Client System 36a) communications between the Client System 36a and the Server 12, as discussed more fully with respect to FIG. 9 below.

The Viewer 42 can be embedded in an application or web browser (e.g., using ActiveX controls) or as a standalone application. If the Viewer 42 is embedded in a CRM application, the requested information is preferably displayed in a familiar format recognizable by the CRM application. For example, if the Viewer 42 is embedded in a native Siebel™ Call Center pane, then the customer information is presented in a format familiar to a user of Siebel™ Call Center. Since the customer information is collected from a wide variety of Source systems 38a, 38b, . . . 38n, the Viewer 42 is said to provide a “360° view” of the customer.

In one embodiment, the Viewer 42 contains a set of UI components, including but not limited to Header, Vital Signs, Navigation, Summary/List, Detail and Search panes. The Header and Vital Signs panes each display a single set of information pertaining to the selected customer. The Navigation pane displays a fixed set of selections, which correspond to categorized customer details. The Search pane is where the user enters data to be used in a search. The Summary/List pane is where the results of a search are displayed.

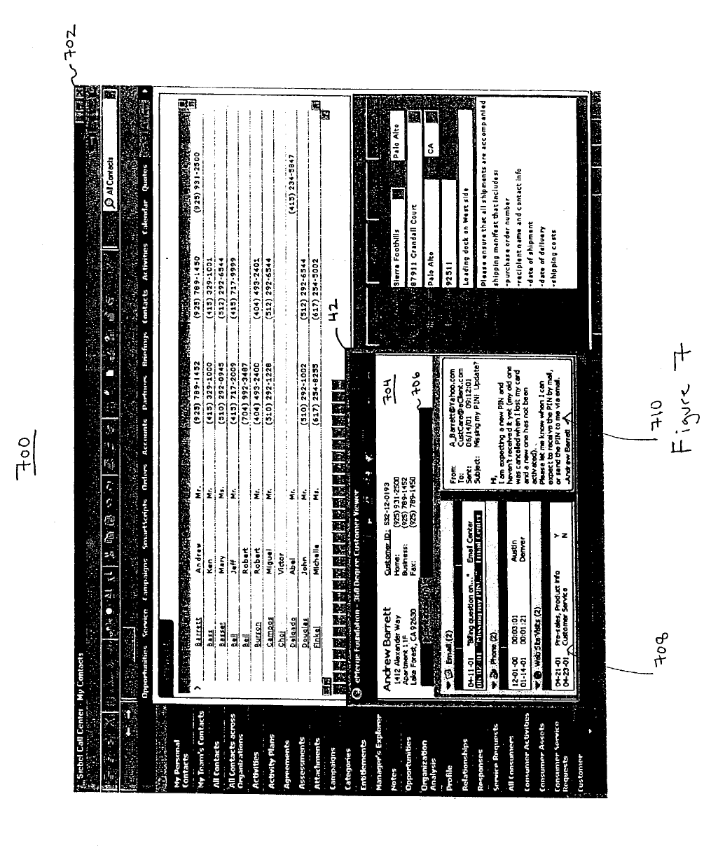

FIG. 7 is a screen shot 700 of the Viewer 42 embedded in a CRM application 702 (e.g., Siebel™ Call Center), in accordance with one embodiment of the present invention. The Viewer 42 includes a Header pane 704, a Navigation pane 706, a Summary/List pane 708, and a Detail pane 710.

In one embodiment, the Header pane 704 displays appropriate Customer ID and contact information (e.g., address, telephone number) in a familiar format used by the application 702. The Navigation pane 706 enables the user to select a particular tab (e.g., Contacts) for display. The Contacts tab includes the Summary/List pane 708, which, in this example, is divided into email, telephone and Web Site categories. The user can drill down to detailed data for each of these categories by clicking on the desired file within a particular category using a mouse or other input device. For example, the user can review an email message regarding the selected customer's missing Personal Identification Number (PIN) sent to the “Email Center” on Jun. 2, 2001, and the content of the email is displayed in the Detail pane 710.

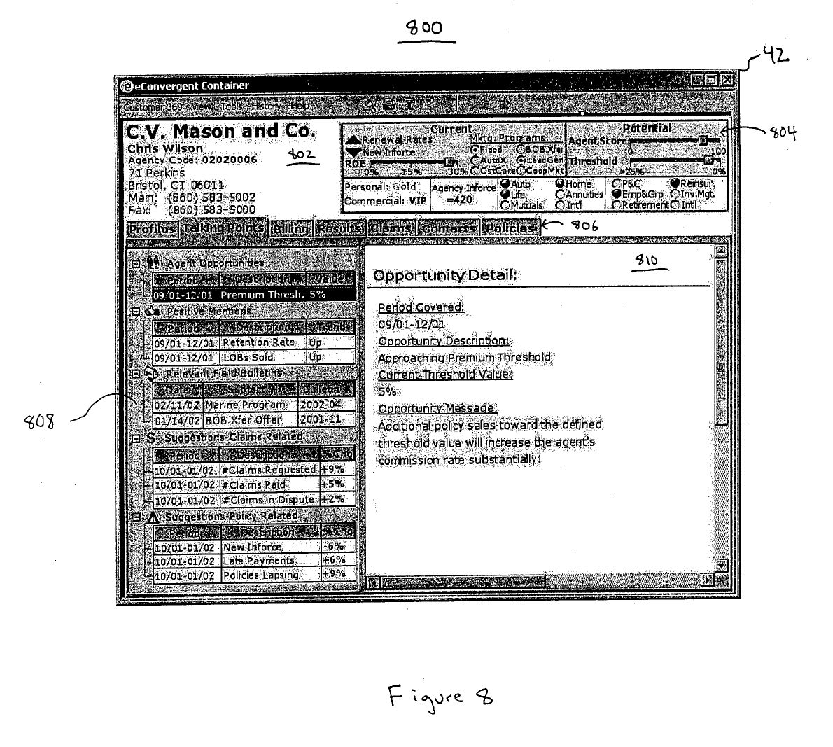

FIG. 8 is a screen shot 800 of the Viewer 42 as a standalone application (e.g., ActiveX thick-client), in accordance with one embodiment of the present invention. The Viewer 42 includes a Header pane 802, a Vital Signs pane 804, a Navigation pane 806, a Summary/List pane 808 and a Detail pane 810.

The Header pane 802 displays high-level context information about the selected customer, such as name, postal address, telephone and email address (both for businesses and individuals or consumers). Typically, the display of header information is formatted text, with the emphasis on font and color variations to highlight specific data. The Vital Signs pane 804 displays high-level indicative information about the selected customer, such as lifetime value, customer tier (e.g., silver, gold, etc.) and other information, which indicates the cost and/or value of the customer. In one embodiment, the display of the Vital Signs pane 804 uses graphical “widgets” to represent the information rather than being primarily text-based. The Navigation pane 806 provides a selectable set of buttons, tabs or other appropriate UI constructs to give the user an efficient way to get through a complex hierarchy of customer information. The Summary/List pane 808 displays a summary of specific categories of customer information, such as emails, orders or billing. The Summary/List pane 808 provides the user with a list of summarized information for individual data items (e.g., all date, time and subject line of emails sent to or received from the customer). There can be multiple Summary/List panes, depending upon the selection made in the Navigation pane 806. The Detail pane 810 displays further details about a specific item selected in the Summary/List pane 806. The Detail pane 810 displays the rest of the information about the selected item (e.g., the email body, to: and from: data). The Detail pane 810 can also repeat the information for the item, which was selected on the Summary/List pane 808 (e.g., the email date, time and subject line), so as to give the user a complete picture of that particular item.

Security

An important feature of the present invention is the ability to hide certain information from a user based on the role of the user (e.g., job title, department) in the organization and/or the user's security profile. For example, an employee in the service department of an organization may not be authorized to view information from the sales department. Similarly, a rank-and-file employee may not be authorized to view the same information as the department manager or senior vice president. To provide such security, various known security methods can be used with the present invention. These methods include, but are not limited to user authentication, user authorization and data field encryption. User authentication is implemented using well-known encrypted-password authentication techniques and certificates (e.g., DES, RSA). User authorization is preferably implemented in the Server 12 based on the role of the user and/or the user's security profile, which is configurable via the Administrator System 32. Data field encryption is performed using, for example, PGP public-key encryption or an equivalent cryptography package for communicating over the Middleware Bus 52 and, for example, Secure Socket Layer (SSL) for communicating between the Client System 36a and the Server 12 over the communication link 51.

UI Services/UI Client Protocols

FIG. 9 is a block diagram illustrating an application server environment 900 for providing the services and protocols used to manage communications between the Server 12 and one or more Client System 36a, 36b, . . . 36n, in accordance with one embodiment of the present invention. These services and protocols provide the means for displaying 360° customer views and real-time statistics, and for providing a means for desktop CRM application integration. The UI Services module 22 located in Server 12 includes a Client Connection module 902, a Resource Management module 904, a Message/Event Management module 906, a UI Server Controller 908 and an Adapter Services module 910. The Client System 36a includes Server Connection module 901, Viewer Controller 44 and Container 914 (i.e., a class of objects). The Container 914 includes Desktop Connection Module 916, which is coupled to the Viewer 42 via the Desktop Connection 916.

The UI Services module 22 is connected to the Client System 36a via communication link 51. The Client Connection module 902 and the Server Connection module 901 comprise one or more software objects that interact to manage the communication link 51 and associated protocols for the Client System 36a and the Server 12. In one embodiment, the communication link 51 is a TCP socket connection that maintains a data and control path between the Client System 36a and the Server 12. The communication link 51 is preferably initiated from the Client System 36a to the server 12 and is bi-directional. The data transmitted over the link 51, includes but is not limited to Tag/Value messages, Hypertext Markup Language (HTML), XML, and Universal Resource Locators (URLs). The content of the data transmitted over the link 51, includes but is not limited to customer details and messaging information. The link 51 can also be used to control an agent state and/or desktop configuration.

The Resource Management module 904 comprises one or more software objects that interact to maintain the user session and related information. Preferably, each connection between the Client System 36a and the Server 12 creates a new instance of the Resource Management module 904.

The Message/Event Management module 906 comprises one or more software objects that interact to monitor incoming events and messages and initiates the relevant processing in the UI Service Controller 908 and/or Resource Management module 904. In one embodiment, a number of instances of the UI Service Controller 908 can be created to achieve proper load balancing.

The Adapter Services module 910 provides an interface to Middleware Bus 52 and can be implemented as a Java™ Message Oriented Middleware (JMOM) adapter. A single multi-threaded instance of the module 910 is preferred. The Bus 52 is coupled to the Middleware Services module 40 and the Server 12 for collecting customer information from one or more disparate Source Systems 38a, 38b, . . . 38n (e.g., report queries). The Server 12 can track agent status and authenticate agents and customers.

The UI Service Controller 908 comprises one or more software objects that interact to manage other objects and threads in Server 12. In one embodiment, the UI Server Controller 908 is coupled to a UI Configuration Database 924 for storing UI Configuration Data, which is used to determine the look and feel (e.g., layout, colors, etc.) of the Viewer 42. The UI Server Controller 908 uses ODBC and/or JDBC connection protocols to access the configuration information in the UI Configuration Database 924.

The UI Component Controller 44 manages data, desktop configurations (e.g., object placement) and interactions between other components in the Client System 36a.

The Desktop Connection 916 resides in Container 914 and comprises one or more software objects that interact to manage the desktop protocol for the Viewer 42.

The Viewer 42 presents the individual UIs to the user, as previously described with respect to FIGS. 7 and 8. In one embodiment, the Viewer 42 is embedded in one or more Container 914 applications that support ActiveX controls and provides method and event interfaces to the one or more Container applications 914. Container 914 applications, include but are not limited to CRM applications that support embedded customer controls (e.g., Siebel™ client applications), browsers that support the use of ActiveX (e.g., Internet Explorer™ version 5.0), and custom Win32™ applications. These UIs provided by the Viewer 42 provide bi-directional control of the Container 914 applications, such as a screen pop up in a Siebel™ client application or message publication based on an action in the Siebel™ client application. The Viewer 42 communicates directly with the Server 12, and can display web content through an Internet Explorer™ OLE customer control (IE OCX), which is embedded in the Viewer 42.

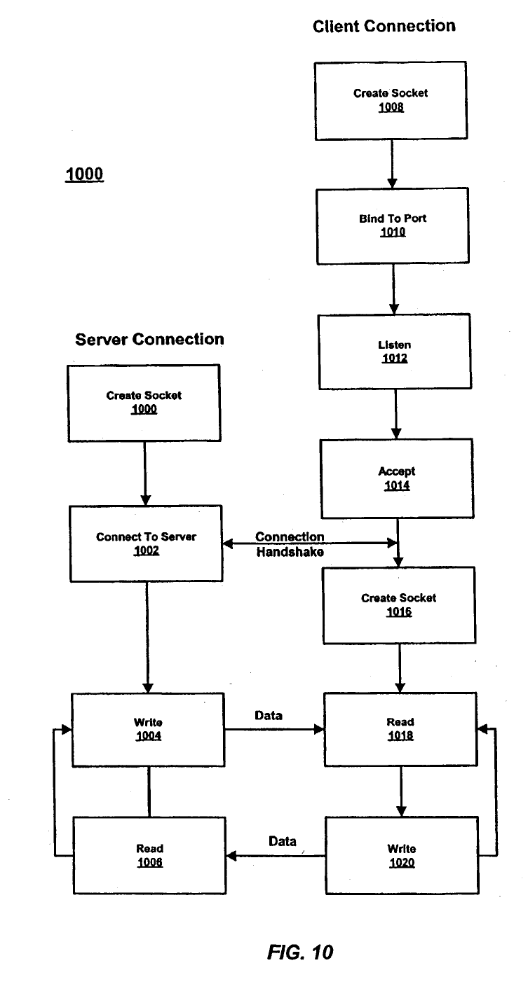

FIG. 10 is a flow diagram of a connection instantiation process 1000, in accordance with one embodiment of the present invention. The connection instantiation process 1000, for establishing the connection 51 shown in FIG. 9 is handled by the Server Connection module 901 and the Client Connection module 902. On the client side, connection instantiation process 1000 includes creating 1001 a TCP socket, connecting 1002 to the Server 12 via the socket (e.g., connection handshake), reading 1004 data from the Server 12 and writing 1006 data to the Server 12. On the server side, the connection instantiation process 1000 includes creating a TCP socket 1008, binding to a port 1010, listening 1012 for a request to communicate from a client system (e.g., Client System 36a), accepting 1014 the request, creating another TCP socket 1016, reading 1018 data from the Client System 36a and writing 1020 data to the Client System 36a. If the server connection 901 is closed, a message is sent to the UI Component Controller 44 to either close or display a disconnected message and a message is sent to the Server 12 to close the Client Connection 902. If the Server 12 fails when attempting to write 1020 to the Client System 36a the Client Connection 902 will be closed. If the Client System 36a fails when trying to read 1006 or write 1004 to the Server 12, the Server Connection 901 will be closed and the connection will be attempted again.

Examples of messages used by above described protocol, include but are not limited to Session Request, Session Request Response, Session Closed, Client Server Command (message sent from the Viewer 42 to the UI Service Controller 908 requesting information) and Server Client Command (message sent from the UI Service controller 908 to the Viewer 42 updating information). Table I below describes the layout of the Session Request header used to establish the link 51 between the Server 12 and the Client System 36a, in accordance with one embodiment of the present invention.

TABLE I
Message Header Layout

| | Size | | |
|---|---|---|---|
| Field | (bytes) | Description | Valid Entries |
| Version | 4 | Version of particular header | 1.0 |
| | | format and message | |
| | | definitions | |
| Message ID | 4 | Identifies the message to be | Connection |
| | | sent | Request |
| Payload Size | 8 | Size of message payload | 1200 bytes |
| Payload Type | 4 | Indicates the format of the | Tag/Value pair, |
| | | payload | XML |
| Destination | 4 | Destination for the message | 360 Viewer |
| Source | 4 | Message creator | UI Server |
| Globally Unique | 32 | Unique ID for message | N/A |
| Identifier (GUID) | | | |

360-Degree Server Architecture

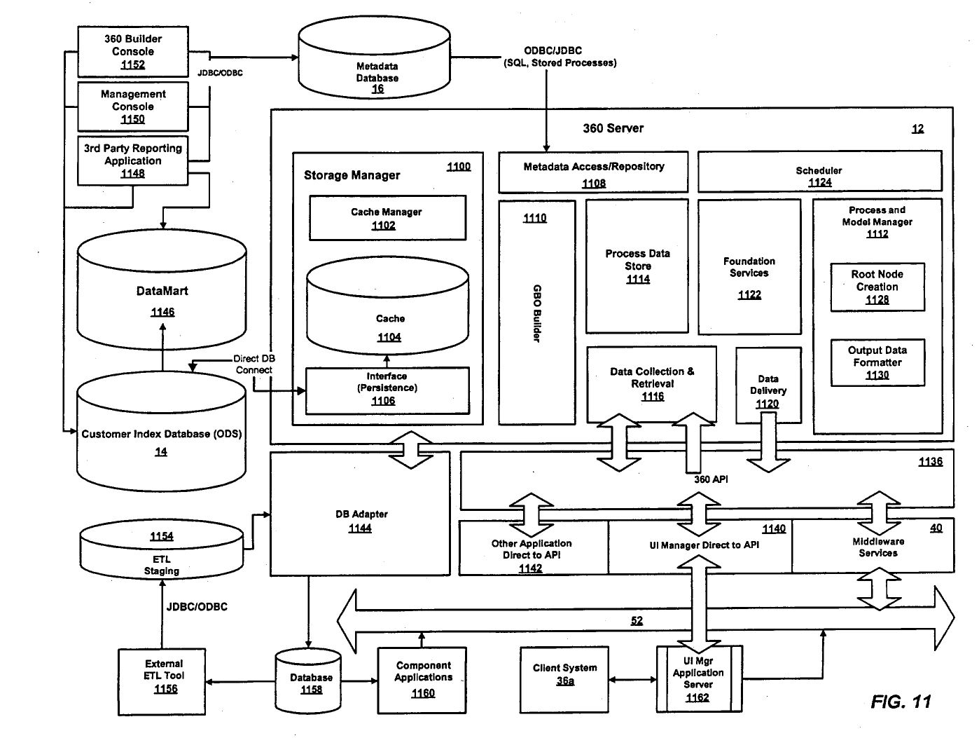

FIG. 11 is a block diagram of the architecture of the Server 12 shown in FIG. 1, in accordance with one embodiment of the present invention. The Server 12 is generally responsible for collecting customer data from disparate Source Systems 38a, 38b, . . . 38n and storing the information in the Customer Index Database 14. If any of the collected data already exists in the Customer Index Database 14, the new information will be correlated and merged with the existing information. If collected data is incomplete, the Server 12 will gather information from other Source Systems 38a, 38b, . . . 38n to build a full 360-degree view of the customer. If data cannot be collected in a satisfactory manner then a resolution/fault event is logged. The Server 12 also provides a mechanism for querying the Customer Index Database 14 and returning structured result sets in accordance with configurable metadata and process models located in the Metadata Database 16.

In one embodiment, the Server 12 includes a Storage Manager 1100, a Metadata Access/Repository 1108, a Generic Business Object (GBO) builder 1110, a Process and Model Manager 1112, a Process Data Store 1114, a Data Collection and Retrieval module 1116, a Data Delivery module 1120, a Foundation Services module 1122, and a Scheduler 1124.

The Storage Manager 1100 includes a Cache Manager 1102, a Cache 1104 and a Persistent Interface 1106. The Cache 1104 stores a GBO for each customer. Read and write transactions to and from the Cache 1104, are managed by Cache Manager 1102. The Cache Manager 1102 also manages garbage collection routines for reallocating unused memory in the Cache 1104. The Storage Manager 1100 communicates with the Customer Index Database 14 via Interface 1106 and a direct database connection.

The Scheduler 1124 uses information stored in the Metadata Database 16 to schedule process models (e.g., Process Model 1800) to run at a specific time with specific input data. The result of a process model run by the Scheduler 1124 is stored in the Customer Index Database 16. Since a process model run by the Scheduler 1124 is typically not associated with an end-user of the 360 Degree Viewer 42, most process models run this way would not return results to an end-user, but may return results to another application through an Adapter (e.g., Adapter 50a).

The Foundation Services module 1122 provides a consistent set of software tools for solving various programming problems, including but not limited to logging functions (e.g., errors, warning, debugging, etc.), Internet Protocol (IP) functions (e.g., sockets, queues, pipes, files, bus, outbound and dispatch of inbound events to registered processes), timing functions (e.g., configurations for interval and/or time of day), creating Globally Unique Identifiers (GUID), security functions (e.g., username/password management), encryption (e.g., message content encryption and ciphers for username/password), disk file and directory management, compression and archive (e.g., log file compression and archive), system metrics (e.g., response times, pool wait times and request overflows, etc.), and data transformation (e.g., time and date conversion, byte ordering).

Metadata Access/Repository

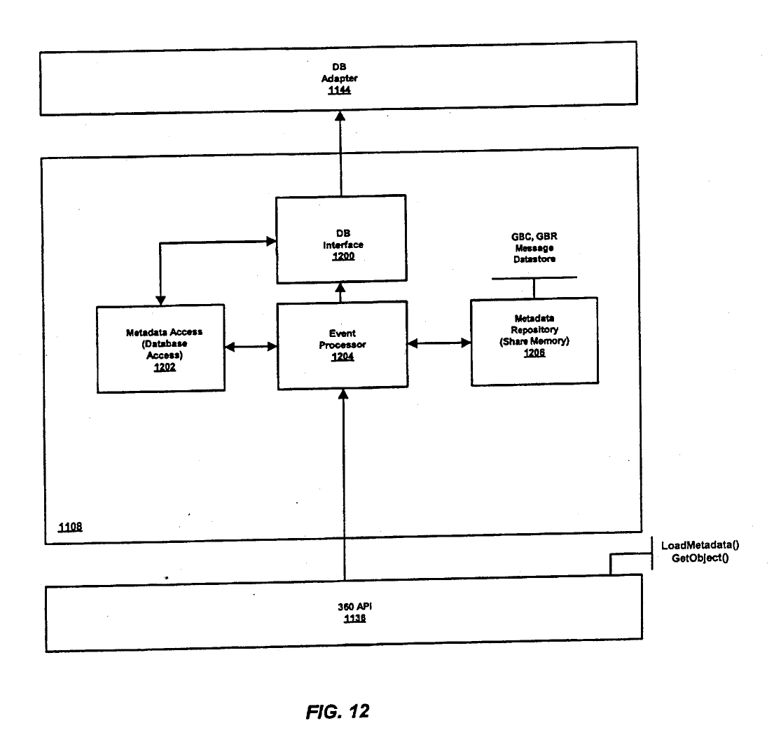

FIG. 12 is a block diagram of the Metadata Access/Repository 1108 shown in FIG. 11, in accordance with one embodiment of the present invention. The Metadata Access/Repository 1108 includes a Database Interface 1200, a Metadata Access module 1202, an Event Processor 1204 and a Metadata Repository 1206. Request messages (e.g., LoadMetadata( ), GetObject( )) are received through the 360 API 1136 and are processed by the Event Processor 1204. The Event Processor 1204 is coupled to the Metadata Access module 1202 and the Metadata Repository 1206.

Upon system initialization the LoadMetadata( ) message is generated and received by the Event Processor 1204. The Event Processor 1204 calls the Metadata Access module 1202, which constructs database queries to retrieve metadata from, for example, the Metadata Database 16. These queries are then passed to the DB Interface 1200, which uses the DB Adapter 1144 to actually query the database. The results of the database queries are returned to the Event Processor 1204, which then caches the metadata in the Metadata Repository 1206 for quick access.

In one embodiment, the Metadata Repository 1206 stores GBOs, Generic Business Relationships (GBRs) and messages that are retrieved by the Event Processor 1204 in response to a GetObject( ) request message. The Metadata Repository 1206 can be implemented as shared memory.

In one embodiment, the Metadata Access module 1202 provides access to the Metadata Database 16 so that metadata can be loaded by the Event Processor 1204 in response to a LoadMetadata( ) request message.

DB Adapter

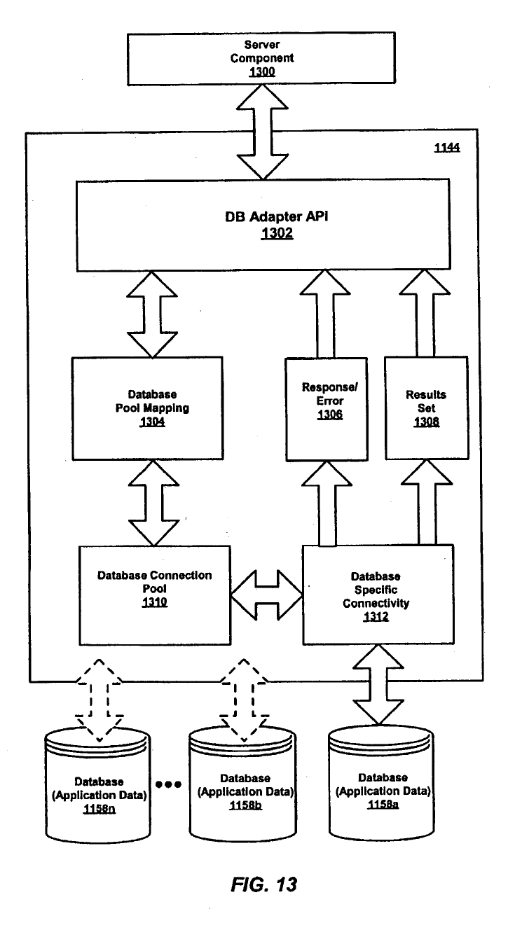

FIG. 13 is a block diagram of the Database Adapter 1144 shown in FIG. 12, in accordance with one embodiment of the present invention. The Database Adapter 1144 includes DB Adapter API 1302, Database Pool Mapping module 1304, Database Connection Pool 1310 and Database Specific Connectivity module 1312. Various Server Components 1300 in Server 12 (e.g., Metadata/Repository module 1108) can request data from one or more databases via API 1302. The data requests are processed by the Database Pool Mapping module 1304, which provides data source to connection mapping for various databases in the Database Connection Pool 1310. Once a request is mapped to the appropriate database 1158a, 1158b, . . . 1158n in the Database Connection Pool 1310, the Connectivity module 1312 establishes a connection with one of the Databases 1158a, 1158b, . . . 1158n. The requested data (e.g., application data) can be retrieved directly from the database and provided to the requesting Server Component 1300 in the form of a Response/Error Message 1306 and/or a structured Result Set 1308.

Alternatively, data can be extracted from databases 1158a, 1158b, . . . 1158n using an Extraction, Transformation and Loading (ETL) Tool 1156 coupled to an ETL Staging Database 1154 to help manage replicated data.

As shown in FIG. 1, the Metadata Database 16 is coupled to a 360° Builder Console 1152, a Management Console 1150 and/or a Reporting Application 1148 using known connection technologies and protocol (e.g., ODBC/JDBC). The 360° Builder console 1152 allows a user to build and update a metadata model, as described with respect to FIGS. 17-20. The Management Console 1150 allows a system administrator to manage and configure the various components of the Server 12. One or more Reporting Applications 1148 can be used to populate the Customer Index Database 14 and/or a DataMart 1146.

The Storage Manager 1100 functions as a transparent interface for customer information, whether that information is accessed directly from the Customer Index Database 14, or is cached in the Cache 1104. The Metadata Access Repository 1108 is used for initialization of the 360 Server 12 memory with the metadata stored in the Metadata Database 16. The Data Collection & Retrieval 1116 and Data Delivery 1120 components are responsible for receiving processing requests from the 360 API 1136 (and ultimately from the Message Bus 50), managing the internal processing of the 360 Server 12 with respect to that received request, and delivering any response data which might be defined by a process model. The Process and Model Manager 1112 determines what process model to run for a given request, and uses the GBO Builder 1110 to create an in-memory data structure (the Process Data Store 1114) of the data tree represented by the process model. The Scheduler 1124 is responsible for initiating process models when it is desired to run a process model without user or external application intervention, and the Foundation Services 1122 provides basic CPU threading, object and logging services. The 360 API 1136 is the external interface that other components use to interact with the 360 Server 12.

Middleware Transport Adapter

FIG. 14 is a block diagram of the Middleware Services module 40 shown in FIG. 11, in accordance with one embodiment of the present invention. The Middleware Services module 40 acts as a pass-through facility for messages and data payloads entering or exiting the Server 12 via Middleware Bus 52.

The Middleware Services module 40 includes an Initialization API 1404, an Outbound Message API 1406, an Outbound Message Processor 1408, a Base Common Utilities module 1410, an Inbound Message Processor 1420, a Message ID to Handler Mapping module 1421, a Middleware Adapter Outbound Abstract API 1412, a Middleware Adapter Inbound Abstract API 1414, and a Middleware Adapter Specific Implementation module 1416. The Message ID to Handler Mapping module 1421 further includes a Registration API 1422, an Event Handler 1424 and a Message and Process ID Event Handler Mapper 1426.

The Outbound Message Processor 1408 and Inbound Message Processor 1420 process the outbound and inbound messages, respectively, using techniques disclosed in U.S. application Ser. No. 09/915,492, entitled “Method Integration Framework For Multi-Application Systems,” filed Jul. 25, 2001. The Outbound Message Processor 1408 performs the function of adding the default header information (e.g., time stamps, unique identifiers, application identifiers) to the message that is sent. The Outbound Message API 1406 is used by the calling application to send messages.

The Middleware Services module 40 provides a vendor-independent interface to middleware, for sending and receiving messages. The Middleware Adapter Outbound Abstract API 1412 and Middleware Adapter Inbound Abstract API 1414 provide an internal abstraction of sending (outbound) and receiving (inbound) messages. The Middleware Adapter Specific Implementation 1416 encapsulates the vendor-specific source code to integrate with specific third-party middleware products (e.g., IBM MQSeris, TIBCO, etc.), which is represented by the Middleware Library 1418.

The Message and Process ID Event Handler Mapper 1426 provides the capability for a calling an application (e.g., the 360 Server 12) to register a callback function to be run when an un-solicited message is received. The calling application uses the Registration API 1422 to specify the callback function, which is stored internally in the Event Handler (Callback) Registry 1424.

The Base Common Utilities 1410 provide an internal process queue implementation for the Outbound and Inbound Message Processors (1408 & 1420) to communicate with the Middleware Adapter Inbound and Outbound Abstract APIs (1412 & 1414). This ensures that multiple messages in each direction (inbound and outbound) can be processed appropriately and simultaneously.

The Initialization API 1404 provides a calling application with a way to identify itself to the Middleware Services module 40 and ensures that its messages are identified properly.

Data Collection, Retrieval and Delivery

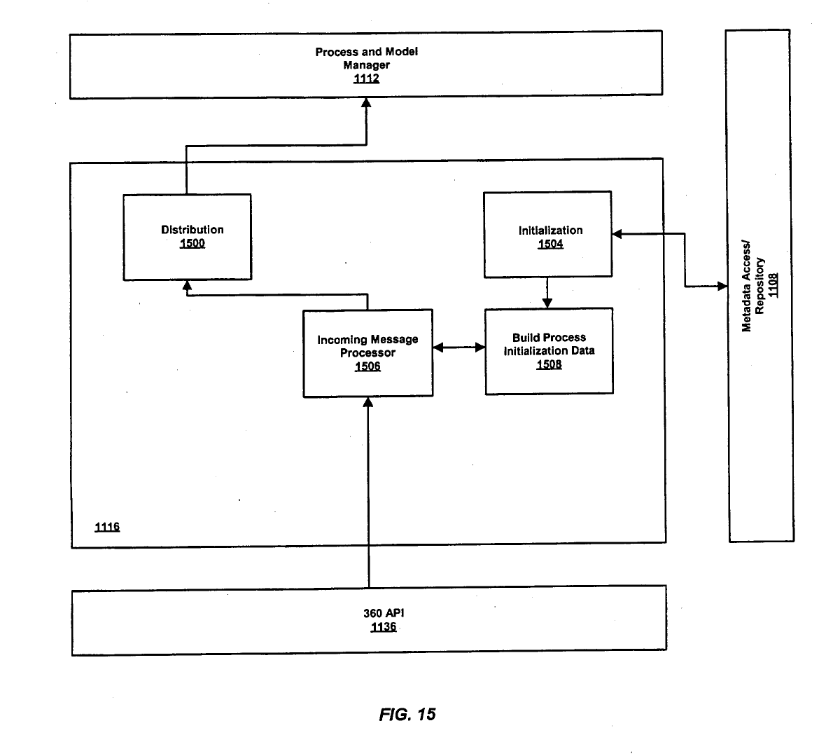

FIG. 15 is a block diagram of the Data Collection and Retrieval module 1116 shown in FIG. 11, in accordance with one embodiment of the present invention. The Data Collection and Retrieval module 1116 includes a Distribution module 1500, an Initialization module 1504, an Incoming Message Processor 1506 and a Build Process Initialization Data module 1508.

In one embodiment, messages are received via the 360 API 1136 and are processed by the Incoming Message Processor 1506. An exemplary message would be collectRetrieveMsg (msgType, msgGUID, payloadPtr, responseAddress), which preferably includes several parameters, including but not limited to a message type (msgType), a message GUID (msgGUID), a payload pointer (payloadPtr), and a response address).

The Distribution module 1500 determines the appropriate process model to be run for the incoming message, and calls the Process and Model Manager 1112 to run the process model with the incoming message data. The Initialization module 1504 uses the Metadata Access Repository 1108 to associate all the defined incoming messages with process models and creates the Build Process Initialization Data 1508, which is stored in memory to facilitate efficient processing.

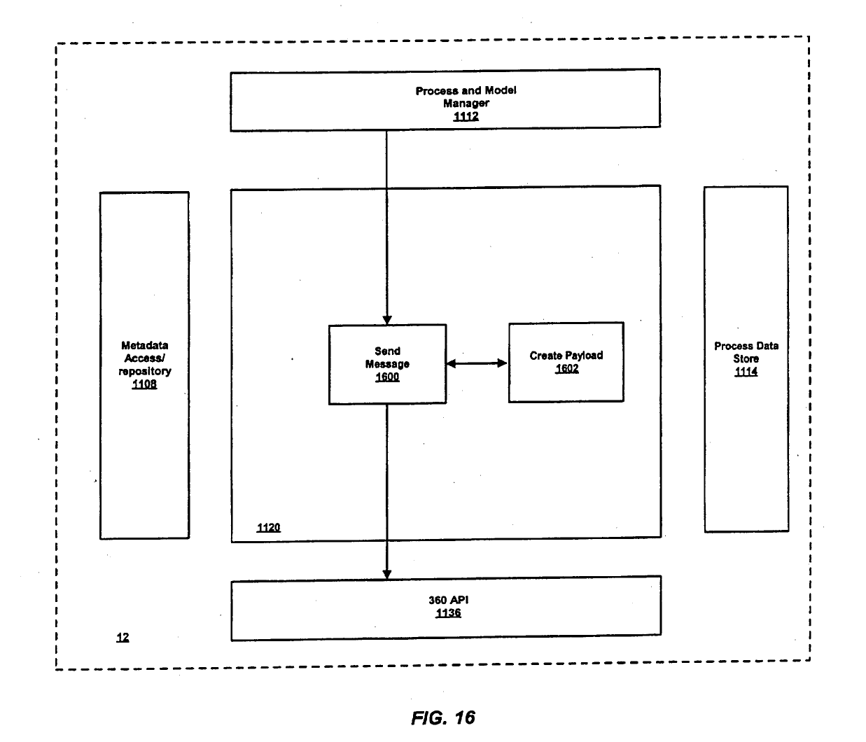

FIG. 16 is a block diagram of the Data Delivery module 1120 shown in FIG. 11, in accordance with one embodiment of the present invention. The Data Delivery module 1120 includes a Send Message Processor 1600 and a Create Payload module 1602. The Send Message Processor 1600 is coupled to the Process and Model Manager 1112 and to the 360 API 1136 to facilitate the routing of messages between the Process and Model Manager 1112 and the 360 API 1136. The Send Message Processor 1600 is also coupled to the Create Payload module 1602, which creates data payloads for messages processed by the Send Message Processor 1600.

In one embodiment, an exemplary message is sendMSG(msgGUID, msgType, payload, responseAddress), which preferably includes several parameters, including but not limited to a message GUID (msgGUID), a message type (msgType), a payload (payload), and a response address (responseAddress).

The Send Message 1600 processor receives a pointer to the data in the Process Data Store 1114 from the Process and Model Manager 1112, and then calls Create Payload 1602 to create a middleware message which represents the specific data, by creating message keyword and value pairs from the data structure in the Process Data Store 1114. The Send Message processor 1600 then calls the 360 API 1136, which in turn passes the message to be sent to the Middleware Services module 40.

Process and Model Manager/Process Data Store

The Process and Model Manager 1112 includes a Root Node Creation module 1128 and an Output Data Formatter 1130. The Root Node Creation module 1128 works with the Process and Model Manager 1112 by initiating a process model. It copies the keywords and values from the incoming message to the data structure, which represents the first node (the root node) in the process model. The Process and Model Manager 1112 then traverses each node in the process model, calling the GBO Builder 1110 for each node to create a tree structure in memory which represents the process model instantiated for the incoming message data. For example, an incoming message may contain the customer identifier (such as account number), by which the customer profile information can be built in memory as a GBO (and stored in the Process Data Store 1114), and linked to any other nodes in the process model tree.

The Output Data Formatter 1130 converts the in-memory tree structure of each GBO in the process model to an XML representation of that tree. The Output Data Formatter 1130 uses the metadata provided by the Metadata Access Repository 1108 to define which GBO properties are present in the XML stream (e.g., based on such attributes as DO NOT DELIVER, and based on the role of the user who created the incoming request). The XML data structure is then provided to the Data Delivery module 1120, which sends it out on the Middleware Bus 50 through the 360 API 1136 and Middleware Services module 40.

Process Models

Generally, a process model is a hierarchical description of the relationships between data elements from the perspective of a particular business process, and generally includes nodes, properties, attributes and the relationships between the nodes and the properties of the nodes. Certain process models (e.g., Process Model 1700 described below) are also related to request messages, which contain the data elements necessary for a root node of the process model, and optionally to response messages, which contain the results of running the process model, if the process model produces results. In one embodiment of the present invention, there are at least four types of process models, which are related to UI components (e.g., pane 708 shown in FIG. 7). These process models, referred to as SIGNON, SEARCH, MORE and DETAIL, produce results that are sent to the requesting client system in the payload of a response message, such as the response message sendMsg( ), previously described with respect to FIG. 16.

In the SIGNON process, the user credentials are supplied in the incoming message. These credentials (in one embodiment, user id and password) are used to look up the user authentication and authorization information, which is stored in the Metadata Database 16. The Role Table 17 defines what roles are associated with the user, and in turn define what GBOs and GBO properties the user has access to, and which are hidden from the user. The process model returns a unique identifier for the user's session, which can be deleted when the user signs out, and a new one assigned when the user signs in again. This identifier is preferably provided in all subsequent incoming messages from that user, and is used by the Server 12 to define the other process models that can be run, and which data (if any) may be hidden from that user.

The SEARCH process handles search requests for customer information and returns the results of the search to the user via a response message. The result of SEARCH is displayed on the Viewer 42, but the form of that display can vary depending on the context of the search. If the search is not in the context of an existing customer (e.g., a customer search request is configured to indicate the start of a new user interaction), then the search results can be displayed in, for example, a separate pane (e.g., a search pane) in the Viewer 42. If the search is in the context of an existing customer (e.g., a search for a trouble ticket by date), then the search results can be displayed in, for example, the Summary/List pane 708 shown in FIG. 7. Preferably, SEARCH process models are configurable by the user via, for example, the administrator system 32.

The MORE process provide additional customer information in any particular category of information. An example of a MORE process is where a user requests emails sent to a particular customer and receives only the last 10 emails sent to the customer. To get more than 10 emails, the user sends a request message, which triggers the MORE process to collect and transmit to the user additional emails for the customer. The results received from MORE are displayed on one or more UI components in the Viewer 42 (e.g., the Summary/List pane 708). The location of displayed information in a particular UI component is preferably configurable by the user via metadata located in the Metadata Database 16.

The DETAIL process provides detailed information about a customer. DETAIL may be complex (e.g., requesting various types of related information) or specific to one particular data type. The results of the DETAIL process can be displayed on one or more UI components in the Viewer 42. Preferably, the relationship of the DETAIL process to the UI components (e.g., pane 708) is fully configurable through an administrator computer system (e.g., Administrator System 32) via metadata stored in the Metadata Database 16. The Administrator System 32 allows the user to view the various process models and UI components, and to define which process model nodes are displayed in which UI component. The user can also define what requests are made to get the data displayed in a particular UI component, including what data is sent with the request and where this data comes from (e.g., data from previous requests or provided by the user), what requests are executable depending on the context and the state of the Viewer 42, and where the results of the request are displayed in the Viewer 42.

An important feature of the present invention is the inclusion of process models, which produce structured result sets based on the user's role in, for example, a business enterprise (e.g., job title, security profile). The roles associated with a particular user or set of users collectively define that user's permissions with regard to data that they are able to view. If a single user is associated with more than one role, a superset of permissions associated with these roles can be applied to the user. Roles are defined at the data level, and whenever a query is run, those results of the query are judged against the roles associated with that user, with data access being constrained based on the role associations.

User roles are defined in the Metadata Database 16 and can initially be implemented by a system administrator familiar with the organizational structure and policies of the subject enterprise. Roles are defined in the Metadata Database 16 by making modifications to a Role Table 17 located in the Metadata Database 16 using, for example, a browser running on the Management Console 1150 shown in FIG. 11.

FIG. 17 is a graphical representation of a specific Process Model 1700, in accordance with one embodiment of the present invention. The Process Model 1700 is a DETAIL type process referred to as CUSTOMER_DETAIL_REQUEST, which is triggered by messages requesting detailed customer information. The Process Model 1700 consists of a Root Node 1702, a Header Node 1708, GBR Nodes 1704a, 1704b, . . . 1704i and GBC Nodes 1706a, 1706b, . . . 1706i. The GBR Nodes 1704a, 1704, . . . 1704i represent 1-to-many relationships between parent GBC nodes and child GBC nodes. For example, the Header Node 1708 is related to the child GBC Nodes 1706a, 1706b, . . . 1706h through GBR Nodes 1704a, 1704b, . . . 1704h. Likewise, the GBC Node 1706h is related to the GBC Node 1706i through the GBR Node 1704i.

The Process Model 1700 represents a complex process where a variety of data is collected for a customer. In one embodiment, the DETAIL process models are configured to provide only the data that is permitted to be viewed by the particular user requesting the information based on the user's role(s) and/or security profile, as previously described with respect to FIG. 16. Preferably, when data is retrieved using the DETAIL process, the data retains the hierarchical relationship defined by the process model, thus facilitating a hierarchical presentation to the user via the Viewer 42.

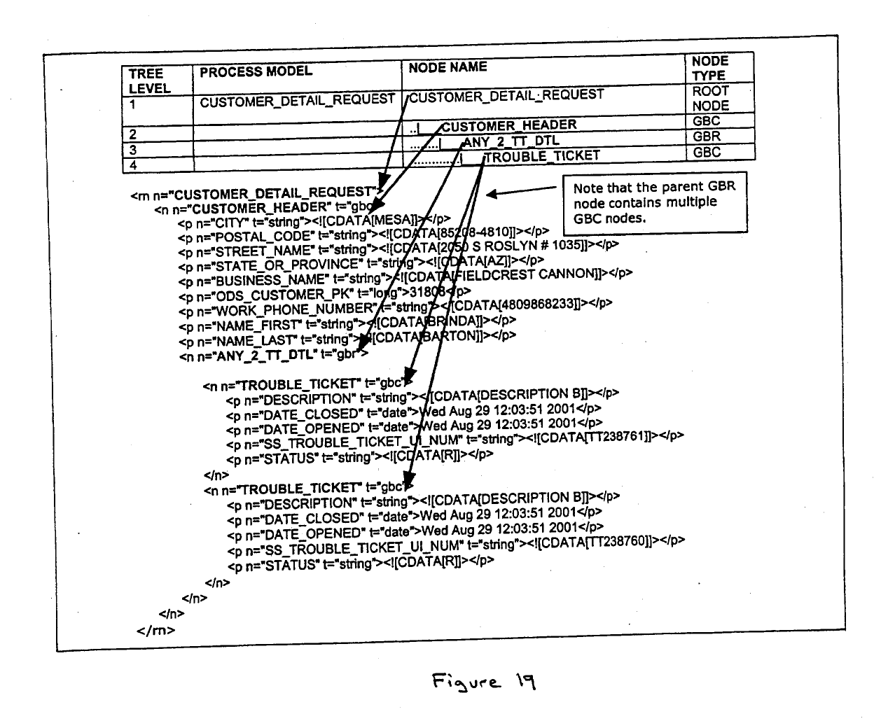

FIG. 18 is a tabular representation of the Process Model 1700 is shown in FIG. 17. The tabular representation shows the relationship between the various GBC and GBR nodes and the level of the tree structure where the nodes reside.

FIG. 19 is tabular representation showing the relationship between the Process Model 1700 shown in FIGS. 17 and 18 and the XML data stream generated from the Process Model 1700, in accordance with one embodiment of the present invention. The Root Node 1702, Header Node 1708, GBR Node 1704a, and GBC Node 1706a, and their relation to the corresponding elements of the XML statements are highlighted.

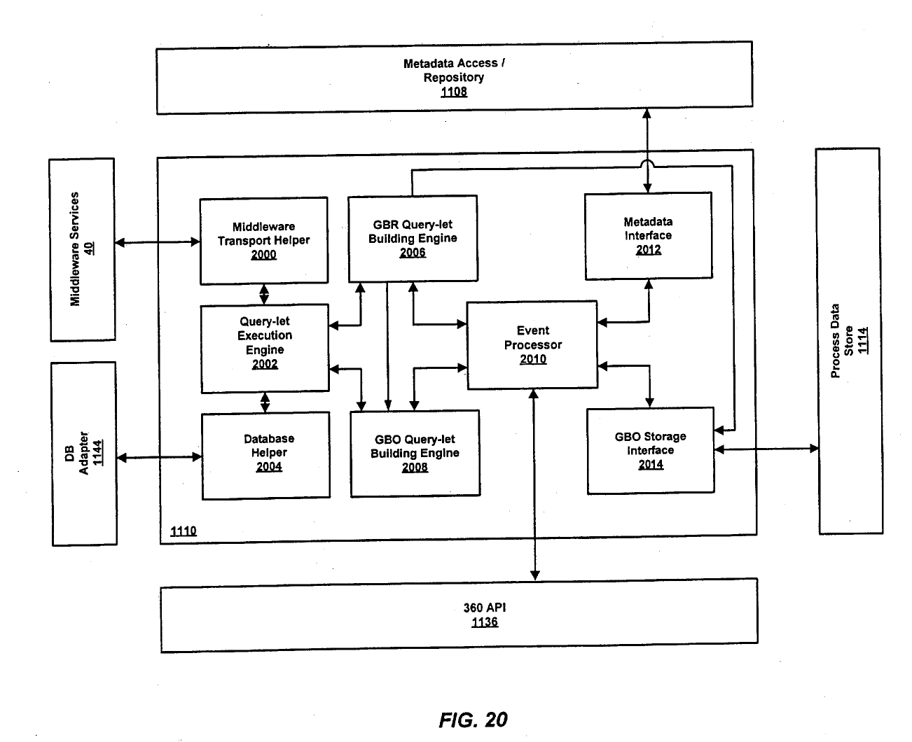

FIG. 20 is a block diagram of the GBO Builder 1110 shown in FIG. 11, in accordance with one embodiment of the present invention. The GBO Builder 1110 includes a Middleware Transport Helper module 2000, a Query-let Execution Engine 2002, a Database Helper module 2004, a GBR Query-let Building Engine 2006, a GBO Query-let Building Engine 2008, an Event Processor 2010, a Metadata Interface 2012, and a GBO Storage Interface 2014. The Event Processor 2010 is coupled to the 360 API 1136, the Metadata Interface 2012 is coupled to the Metadata Access/Repository 1108, the Middleware Transport Helper module 2000 is coupled to the Middleware Services module 40, the Database Helper module 2004 is coupled to the DB Adapter 1144 and the GBO Storage Interface 2014 is coupled to the Process Data Store 1114.

The Event Processor 2010 receives events from the Process and Model Manager 1112, via the 360 API 1136. These events are requests to create business objects in memory, which are stored in the Process Data Store 1114. The Metadata Interface 2012 is used to retrieve metadata, which describes how a GBO is built, including whether the data is retrieved from the Customer Index Database 14 (via the Database Helper 2004 and DB Adapter 1144), or via the Middleware Services module 40 (via the Middleware Transport Helper 2000). Whether the request is for a GBO (single object) or a GBR (multiple objects of the same type) is also determined from the metadata. This determines whether the GBO Query-let Building Engine 2008 or the GBR Query-let Building Engine 2006 is employed to access the data and build the data structure in memory. The Query-let Execution Engine 2002 is passed the query-let, which defines the necessary information that is required to retrieve the requested data, as well as the form the query-let takes. The form of the query-let is an SQL query if the metadata indicates that the data is retrieved from the Customer Index Database 14. The form of the query-let is a middleware keyword-value pair message if the metadata indicates that the data is retrieved via a message passed through Middleware Services 40. When the Query-let Execution Engine 2002 receives a response, the response is returned to the Event Processor 2010 via the appropriate Query-let Building Engine (either the GBO Query-let Building Engine 2008 or the GBR Query-let Building Engine 2006). The GBO Storage Interface 2014 is then used to structure the data and pass it to the Process Data Store 1114.

The above description is included to illustrate the operation of the preferred embodiments and is not meant to limit the scope of the invention. Rather, the scope of the invention is to be limited only by the claims. From the above discussion, many variations will be apparent to one skilled in the relevant art that would yet be encompassed by the spirit and scope of the invention.

What is claimed is:

1. A data integration system, comprising:
a collection module for collecting information in real-time from at least one information source;
a storage device coupled to the collection module for storing a portion of the collected information in accordance with configurable metadata definitions; and
a retrieval module coupled to the storage device for retrieving a selected portion of the collected information from the storage device for presentation to a user, wherein the selection of information is based on the role of the user defined by the configurable metadata definitions.

2. The system of claim 1, wherein the information is collected from a plurality of disparate, Customer Relationship Management (CRM) applications.

3. The system of claim 1, further including
a configurable adapter coupled to the collection module and an information source for translating information from the information source to a format recognizable by the system.

4. The system of claim 1, wherein the storage device includes a configurable hierarchical data structure for storing information.

5. The system of claim 1, wherein the collection module includes a batch processor for collecting data in non-realtime.

6. The system of claim 1, further including
a configurable viewer coupled to the retrieval module for displaying the selected information to a user.

7. The system of claim 6, wherein the viewer is located at a client system.

8. The system of claim 7, wherein the viewer receives the selected portion of information as a structured data stream.

9. The system of claim 8, wherein the structure of the data stream is defined by the configurable metadata definitions.

10. The system of claim 6, wherein the viewer is embedded in a Customer Relationship Management (CRM) application.

11. The system of claim 10, wherein information is displayed to the user in a format that is native to the CRM application.

12. The system of claim 6, wherein the viewer is a standalone desktop application.

13. The system of claim 1, wherein the role of the user includes configurable access rights which determine whether the user can access all or some of the information.

14. A data integration method, comprising:
collecting information in real-time from at least one information source;
storing a portion of the collected information in a storage device in accordance with configurable metadata definitions;
retrieving a selected portion of the collected information from the storage device;
retrieving a selected portion of the information that was not stored in the storage device from the information source; and
combining the two portions of information for presentation to a user, wherein the selection of information is based on the role of the user defined by the configurable metadata definitions.

15. The method of claim 14, wherein the collected information is correlated with information previously stored in the storage device.

16. The method of claim 15, wherein the collected information is correlated using a cross-reference table.

17. A viewer for constructing and presenting a 360-degree customer view of a customer based on data collected from one or more Customer Relationship Management (CRM) applications, comprising:
a viewer for presenting a configurable user interface to a user; and
a controller coupled to the viewer for constructing the user interface in accordance with configuration data and the role of the user.

18. The viewer of claim 17, wherein the viewer is embedded in a CRM application and the user interface is presented in a format familiar to a user of the CRM application.

19. The viewer of claim 17, wherein the user is denied access to portions of the data based on the role of the user.

20. The viewer of claim 17, wherein the controller receives the data as a structured result set in response to a query by the user.

21. The viewer of claim 17, wherein the user interface includes a pane from a group of panes consisting of: a Header pane, a Vital Signs pane, a Navigation pane, a Summary/List pane, and a Detail and Search pane.

22. A process model for use with a system for integrating customer data collected from Customer Relationship Management (CRM) applications, comprising:
a Root node;
a Generic Business Relationship (GBR) node; and
a plurality of Generic Business Class (GBC) nodes, wherein the Root node is the top node in a tree structure that includes the GBR node, a parent GBC node and a child GBC node, and wherein the GBR node embodies a relationship between the parent GBC node and the child GBC node.

23. The process model of claim 22, wherein the GBR node represents a 1-to-many relationship between the parent GBC node and the child GBC node.

24. A data integration system, comprising:
means for collecting information in real-time from at least one information source;
means storing a portion of the collected information in a storage device in accordance with configurable metadata definitions; and
means retrieving a selected portion of the collected information from the storage device for presentation to a user, wherein the selection of information is based on the role of the user defined by the configurable metadata definitions.

25. A computer-readable medium having stored thereon instructions, which, when executed by a processor in a data integration system, cause the processor to perform the operations of:
collecting information in real-time from at least one information source;
storing a portion of the collected information in a storage device in accordance with configurable metadata definitions; and
retrieving a selected portion of the collected information from the storage device for presentation to a user, wherein the selection of information is based on the role of the user defined by the configurable metadata definitions.

26. The computer-readable medium of claim 25, wherein the collected information is correlated with information previously stored in the storage device.

27. The computer-readable medium of claim 25, wherein the collected information is correlated using a cross-reference table.

28. A client-server architecture having a client system and a server system for integrating data collected from disparate Customer Relationship Management (CRM) applications, the server system comprising:
a collection module for collecting and storing customer data collected from at least one of the CRM applications;
a retrieval module for retrieving a structured dataset containing data stored by the collection module in response to a data request from the client system, wherein the structured dataset includes a subset of the requested data based on the security profile of the user; and
a services module for maintaining a communication connection with the client system and for providing the client system with the structured dataset.

29. The server system of claim 28, wherein the structured dataset includes a subset of the requested data based on a role of the user.

30. The server system of claim 29, wherein the user has a plurality of roles and the structured dataset includes a subset of the requested data based on a superset of permissions associated with the roles of the user.

31. A client-server architecture having a client system and a server system for integrating data collected from disparate Customer Relationship Management (CRM) applications, the client system comprising:
a viewer for presenting a configurable user interface to a user;
a controller coupled to the viewer for constructing the user interface in accordance with configuration data; and
a Application Program Interface (API) for receiving a structured dataset from the server system,
wherein the structured dataset includes a subset of the requested data based on the security profile of the user.

32. The client system of claim 31, wherein the structured dataset includes a subset of the requested data based on a role of the user.

33. The client system of claim 32, wherein the user has a plurality of roles and the structured dataset includes a subset of the requested data based on a superset of permissions associated with the roles of the user.

34. A data correlation system for correlating data records collected from disparate Customer Relationship Management (CRM) applications, comprising:
a configurable correlation module for applying a multi-tier correlation process to the data records, wherein a first tier is a deterministic process, a second tier is a heuristic process, and a third tier is a referential process; and
a correlation data structure coupled to the correlation module for storing the results of the correlation process for use in a subsequent correlation process.

35. The data correlation system of claim 34, further comprising:
a normalization/standardization module coupled to the correlation module for translating the data records into a common format prior to applying the correlation process.

36. The data correlation system of claim 34, further comprising:
a data enrichment module coupled to the correlation module for enriching data stored in the data records prior to applying the correlation process.

37. The data correlation system of claim 34, comprising:
a referential database coupled to the correlation module for providing unique keys associated with data records for use in the deterministic correlation process.

38. A method of correlating data records collected from disparate Customer Relationship Management (CRM) applications, comprising:
comparing data fields in a first data record to data fields in a second data record to determine at least one matching field; and, if first data fields in the data records are an exact match and the probability that second data fields in the data records match exceeds a predetermined threshold,
recording a successful match in a data structure for use with a subsequent comparison of data records.

39. The method claim 38 further comprising:
normalizing data in the data records prior to performing the comparing step.

40. The method of claim 38 further comprising:
enriching data in the data records prior to performing the comparing step.

41. A computer-readable medium having contained thereon instructions, which, when executed by a processor in a data correlation system for correlating data records collected from disparate Customer Relationship Management (CRM) applications, cause the processor to perform the operations of:
comparing data fields in a first data record to data fields in a second data record to determine at least one matching field; and, if first data fields in the data records are an exact match and the probability that second data fields in the data records match exceeds a predetermined threshold,
recording successful matches in a data structure for use with a subsequent comparison of data records.

42. The computer-readable medium of claim 41, wherein the operations further comprise:
normalizing data in the data records prior to performing the comparing step.

43. The computer-readable medium of claim 41, wherein the operations further comprise:
enriching data in the data records prior to performing the comparing step.

44. A data correlation system for correlating data records collected from disparate Customer Relationship Management (CRM) applications, comprising:
means for comparing data fields in a first data record to data fields in a second data record to determine at least one matching field; and, if first data fields in the data records are an exact match and the probability that second data fields in the data records match exceeds a predetermined threshold,
means for recording successful matches in a data structure for use with a subsequent comparison of data records.
